(19) United States
(12) Patent Application Publication
(10) Pub. No.: US 2024/0118249 A1
(43) Pub. Date: Apr. 11, 2024

(54) SAMPLE ANALYZER AND SAMPLE ANALYZING SYSTEM

(71) Applicant: SHENZHEN MINDRAY BIO-MEDICAL ELECTRONICS CO., LTD., Shenzhen (CN)

(72) Inventors: Hai LIU, Shenzhen (CN); Jin TENG, Shenzhen (CN); Yantao LI, Shenzhen (CN)

(73) Assignee: SHENZHEN MINDRAY BIO-MEDICAL ELECTRONICS CO., LTD., Shenzhen (CN)

(21) Appl. No.: 18/377,851

(22) Filed: Oct. 9, 2023

(30) Foreign Application Priority Data
Oct. 8, 2022 (CN) 202211223739.X
Sep. 27, 2023 (CN) 202311290488.1

(51) Int. Cl. G01N 30/34; G01N 30/84; G01N 30/86

(52) U.S. Cl. CPC G01N 30/34; G01N 30/84; G01N 30/8689; G01N 2030/347; G01N 2030/8435

(57) ABSTRACT

The disclosure discloses a sample analyzer and a sample analysis system. The sample analyzer includes a first specimen supply device, a chromatographic separation device and a first controller. The chromatographic separation device is controlled by the first controller to elute and chromatograph a first specimen in a first operation mode and to elute and chromatograph a second specimen in a second operation mode. The first controller is configured to: analyze feedback information from the chromatographic separation device in the first operation mode to obtain a parameter of glycosylated hemoglobin in the first specimen and a conclusion as to whether an interfering substance exists in the first specimen, and to analyze feedback information from the chromatographic separation device in the second operation mode to obtain a parameter of glycosylated hemoglobin in the second specimen and a parameter of an interfering substance in the second specimen.

### TECHNICAL FIELD

The disclosure relates to the field of medical equipment, in particular to a sample analyzer and a sample analysis system with the sample analyzer.

### BACKGROUND

HbA1c (glycosylated hemoglobin) is an important index for diabetes screening. Liquid chromatography is a common method to measure HbA1c. An accuracy of the HbA1c measurement is mainly interfered with by interfering substances such as variants, drugs and abnormal proteins. Common variants, such as HbE, HbD, HbS and HbC, interfere with a calculation of chromatographic area of HbA0 (non-glycosylated hemoglobin), resulting in a lower measured value of HbA1c than a true value.

Glycosylated hemoglobin analyzer (such as High Performance Liquid Chromatograph, HPLC) has requirements for a measurement speed and accuracy. The accuracy of the measurement mainly depends on an ability to eliminate the interference of the variants from the glycosylated hemoglobin analyzer. With the increase of diabetic patients, the requirement for the measurement speed also increases accordingly.

The glycosylated hemoglobin analyzers provided by the related art may be broadly categorized as follows.
(1) Both a fast mode and variant mode are provided, and its main disadvantage is that the variant mode and fast mode are realized by using two sets of eluents with different components and two chromatographic columns respectively. If a user needs to take into account the requirements of speed and accuracy, he needs to purchase two sets of eluents with different components and two chromatographic columns.
(2) One set of eluent and one chromatographic column are used, and its main disadvantage is that only the variant mode is available, and its measurement speed is relatively slow.
(3) Two sets of eluents and one chromatographic column are used to realize the variant mode and fast mode, and its main disadvantage is that the user cannot determine which mode to use for testing when facing an unknown sample.

### SUMMARY

The first object of the disclosure is to provide a sample analyzer, which aims to solve the technical problem that both the measurement speed and accuracy cannot be taken into account when a parameter of glycosylated hemoglobin is detected by using liquid chromatography in the related art.

To this end, the disclosure provides a sample analyzer including a first specimen supply device, a chromatographic separation device and a first controller.

The first specimen supply device is configured to supply at least a first specimen and a second specimen to the chromatographic separation device, respectively.

The chromatographic separation device is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode.

The first controller is configured to analyze feedback information from the chromatographic separation device in the first operation mode to obtain a parameter of glycosylated hemoglobin in the first specimen and a conclusion as to whether there is an interfering substance in the first specimen.

The first controller is further configured to analyze feedback information from the chromatographic separation device in the second operation mode to obtain a parameter of glycosylated hemoglobin in the second specimen and a parameter of an interfering substance in the second specimen.

In an implementation, the chromatographic separation device includes a chromatographic column, an eluent supply device and a first optical detection assembly.

The first specimen supply device is configured to supply at least the first specimen and the second specimen to the chromatographic column, respectively.

The eluent supply device is controlled by the first controller to prepare a first liquid and a second liquid into an eluent, and to supply eluents containing the second liquid with different concentrations to the chromatographic column respectively.

The chromatographic column is configured to elute the first specimen and the second specimen with the eluents respectively.

The first optical detection assembly is configured to perform the chromatographic analysis on the first solution to be detected that is obtained by eluting the first specimen in the chromatographic column and the second solution to be detected that is obtained by eluting the second specimen in the chromatographic column respectively.

The first controller is further configured to control the eluent supply device to prepare the first liquid and the second liquid into the eluents containing the second liquid with different concentrations according to a first concentration control mode in the first operation mode, and to supply the eluents containing the second liquid with different concentrations to the chromatographic column respectively, so as to elute the first specimen in the chromatographic column.

The first controller is further configured to control the eluent supply device to prepare the first liquid and the second liquid into the eluents containing the second liquid with different concentrations according to a second concentration control mode in the second operation mode, and to supply the eluents containing the second liquid with different concentrations to the chromatographic column respectively, so as to elute the second specimen in the chromatographic column.

The first concentration control mode is different from the second concentration control mode.

In an implementation, the first controller is further configured to control the chromatographic separation device to elute the first specimen in the first operation mode and elute the second specimen in the second operation mode, using the same chromatographic column.

In an implementation, the eluent supply device includes a mixing component, a first infusion power component and a second infusion power component.

The first infusion power component is configured to deliver the first liquid from a first container to the mixing component.

The second infusion power component is configured to deliver the second liquid from a second container to the mixing component.

The mixing component is configured to supply the eluents formed by at least one of the first liquid and the second liquid to the chromatographic column.

The first controller is further configured to control the mixing component to supply the eluents containing the second liquid with different concentrations to the chromatographic column by controlling operating parameters of the first infusion power component and the second infusion power component, respectively.

In an implementation, elution duration of the first specimen by the chromatographic separation device in the first operation mode is shorter than that of the second specimen by the chromatographic separation device in the second operation mode.

In an implementation, the first operation mode includes a first elution stage, a second elution stage and a third elution stage arranged in sequence, and the second operation mode includes a fourth elution stage, a fifth elution stage and a sixth elution stage arranged in sequence.

The first elution stage and the fourth elution stage are used for eluting and analyzing the glycosylated hemoglobin in the first specimen and the glycosylated hemoglobin in the second specimen respectively. The second elution stage and the fifth elution stage are used for eluting and analyzing non-glycosylated hemoglobin in the first specimen and non-glycosylated hemoglobin in the second specimen respectively. The third elution stage is used for eluting and analyzing the interfering substance in the first specimen. The sixth elution stage is used for eluting and analyzing the interfering substance in the second specimen.

A concentration of the second liquid in an eluent used in the third elution stage is greater than a concentration of the second liquid in an eluent used in the first elution stage and greater than a concentration of the second liquid in an eluent used in the second elution stage.

A concentration of the second liquid in an eluent used in the sixth elution stage is greater than a concentration of the second liquid in an eluent used in the fourth elution stage and greater than a concentration of the second liquid in an eluent used in the fifth elution stage.

The eluents are prepared from at least one of the first liquid and the second liquid, and an ionic strength of the first liquid is less than an ionic strength of the second liquid.

In an implementation, the concentration of the second liquid in the eluent used in the second elution stage is greater than the concentration of the second liquid in the eluent used in the first elution stage.

The concentration of the second liquid in the eluent used in the fifth elution stage is greater than the concentration of the second liquid in the eluent used in the fourth elution stage.

In an implementation, the first elution stage transitions to the second elution stage in a time period close to the second elution stage with a tendency to gradually increase the concentration of the second liquid in the eluent, and the fourth elution stage transitions to the fifth elution stage in a time period close to the fifth elution stage with a tendency to gradually increase the concentration of the second liquid in the eluent.

The concentration of the second liquid in the eluent used in the time period, close to the second elution stage, in the first elution stage varies to a greater extent than the concentration of the second liquid in the eluent used in the time period, close to the fifth elution stage, in the fourth elution stage.

In an implementation, a concentration of the second liquid in an eluent used in a transition interval between the second elution stage and the third elution stage varies to a greater extent than a concentration of the second liquid in an eluent used in a transition interval between the fifth elution stage and the sixth elution stage.

In an implementation, duration of the fifth elution stage is longer than duration of the second elution stage; and/or, duration of the sixth elution stage is longer than duration of the third elution stage.

In an implementation, duration of the first elution stage is longer than duration of the second elution stage and longer than duration of the third elution stage.

In an implementation, the first controller is further configured to analyze the feedback information from the chromatographic separation device to obtain a chromatographic curve in the first operation mode, and to determine that there is an interfering substance in the first specimen when more than two peaks are formed in the chromatographic curve obtained in the second elution stage and the third elution stage; and/or, the first controller is further configured to analyze the feedback information from the chromatographic separation device to obtain a chromatographic curve in the second operation mode. The chromatographic curve obtained in the fifth elution stage and the sixth elution stage shows more than two peaks.

In an implementation, the first controller is further configured to: in response to determining that there is an interfering substance in the first specimen based on the feedback information from the chromatographic separation device in the first operation mode, control the first specimen supply device to supply the second specimen to the chromatographic separation device, and to control the chromatographic separation device to elute the second specimen and to perform the chromatographic analysis on the second solution to be detected that is obtained by eluting the second specimen in the second operation mode.

In an implementation, the first specimen supply device includes a first sample dispensing device, a first reagent dispensing device, a first reaction cell and a first specimen conveying device. The first sample dispensing device is configured to aspirate a sample from a sample container and dispense at least part of the aspirated sample into the first reaction cell. The first reagent dispensing device is configured to aspirate a reagent from a reagent container and dispense the aspirated reagent into the first reaction cell. The first reaction cell is configured to prepare the sample and the reagent into a specimen. The first specimen conveying device is configured to convey the specimen from the first reaction cell to the chromatographic separation device.

The first controller is configured to control the first specimen supply device to supply the second specimen to the chromatographic separation device by: controlling the first sample dispensing device to re-aspirate the sample from the sample container and dispense at least part of the re-aspirated sample into the first reaction cell, controlling the first reagent dispensing device to aspirate the reagent from the reagent container and dispense the aspirated reagent into the first reaction cell, controlling the first reaction cell to prepare the sample and the reagent into the second specimen, and controlling the first specimen conveying device to supply the prepared second specimen to the chromatographic separation device.

In an implementation, the sample analyzer further includes a display.

The first controller is further configured to control the display to display a display interface including at least a chromatographic curve showing a glycosylated hemoglobin peak, a non-glycosylated hemoglobin peak and an interfering substance peak, after elution of the second specimen and chromatographic analysis of the second solution to be detected that is obtained by eluting the second specimen by the chromatographic separation device in the second operation mode are completed.

In an implementation, the sample analyzer further includes a display.

The first controller is further configured to control the display to display a display interface including at least the parameter of the glycosylated hemoglobin in the second specimen and the parameter of the interfering substance in the second specimen, after elution of the second specimen and chromatographic analysis of the second solution to be detected that is obtained by eluting the second specimen by the chromatographic separation device in the second operation mode are completed.

In an implementation, the sample analyzer further includes a display.

The first controller is further configured to: in response to determining that there is the interfering substance in the first specimen based on the feedback information from the chromatographic separation device in the first operation mode, control the display to display a display interface including at least the parameter of the glycosylated hemoglobin in the first specimen and prompt information of presence of the interfering substance in the first specimen.

In an implementation, the sample analyzer further includes a display.

The first controller is further configured to: in response to determining that there is the interfering substance in the first specimen based on the feedback information from the chromatographic separation device in the first operation mode, control the display to display a display interface including at least prompt information of presence of the interfering substance in the first specimen and prompt information as to whether to switch to the second operation mode.

The first controller is further configured to: obtain an instruction for switching to the second operation mode, control the first specimen supply device to supply the second specimen to the chromatographic separation device, and control the chromatographic separation device to elute the second specimen and perform the chromatographic analysis on the second solution to be detected that is obtained by eluting the second specimen in the second operation mode.

In an implementation, the sample analyzer further includes a display.

The first controller is further configured to: in response to determining that there is no interfering substance in the first specimen based on the feedback information from the chromatographic separation device in the first operation mode, control the display to display a display interface including at least the parameter of the glycosylated hemoglobin in the first specimen.

In an implementation, the sample analyzer further includes a display.

The first controller is further configured to control the display to display a display interface including at least a selectable first operation mode and a selectable second operation mode.

In an implementation, the chromatographic separation device is further controlled by the first controller to elute a third specimen and perform chromatographic analysis on a third solution to be detected that is obtained by eluting the third specimen in a third operation mode.

The first controller is further configured to analyze feedback information from the chromatographic separation device in the third operation mode to obtain a parameter of glycosylated hemoglobin in the third specimen.

Elution duration of the third specimen by the chromatographic separation device in the third operation mode is shorter than that of the first specimen by the chromatographic separation device in the first operation mode.

In an implementation, the sample analyzer further includes a display.

The first controller is further configured to control the display to display a display interface including at least a selectable first operation mode, a selectable second operation mode, and a selectable third operation mode.

In an implementation, the chromatographic separation device includes a chromatographic column, an eluent supply device and a first optical detection assembly.

The first specimen supply device is configured to supply the first specimen, the second specimen and the third specimen to the chromatographic column, respectively.

The eluent supply device is controlled by the first controller to prepare a first liquid and a second liquid into an eluent, and to supply eluents containing the second liquid with different concentrations to the chromatographic column respectively.

The chromatographic column is configured to elute the first specimen, the second specimen and the third specimen with the eluents respectively.

The first optical detection assembly is configured to perform the chromatographic analysis on the first solution to be detected that is obtained by eluting the first specimen in the chromatographic column, the second solution to be detected that is obtained by eluting the second specimen in the chromatographic column, and a third solution to be detected that is obtained by eluting the third specimen in the chromatographic column, respectively.

The first controller is further configured to control the eluent supply device to prepare a first liquid and a second liquid into eluents containing the second liquid with different concentrations according to a first concentration control mode in the first operation mode, and to supply the eluents containing the second liquid with different concentrations to the chromatographic column respectively, so as to elute the first specimen in the chromatographic column.

The first controller is further configured to control the eluent supply device to prepare the first liquid and the second liquid into eluents containing the second liquid with different concentrations according to a second concentration control mode in the second operation mode, and to supply the eluents containing the second liquid with different concentrations to the chromatographic column respectively, so as to elute the second specimen in the chromatographic column.

The first controller is further configured to control the eluent supply device to prepare the first liquid and the second liquid into eluents containing the second liquid with different concentrations according to a third concentration control mode in the third operation mode, and to supply the eluents containing the second liquid with different concentrations to the chromatographic column respectively, so as to elute the third specimen in the chromatographic column.

The first concentration control mode, the second concentration control mode and the third concentration control mode are different from one another.

In an implementation, the first controller is further configured to control the chromatographic separation device to elute the first specimen in the first operation mode, elute the second specimen in the second operation mode and elute the third specimen in the third operation mode, using the same chromatographic column.

In an implementation, the third operation mode includes a ninth elution stage and a tenth elution stage arranged in sequence. The ninth elution stage is used for eluting and analyzing glycosylated hemoglobin in the third specimen, and the tenth elution stage is used for eluting and analyzing non-glycosylated hemoglobin and interfering substance in the third specimen.

The first controller is further configured to analyze feedback information from the chromatographic separation device to obtain a chromatographic curve in the third operation mode. The chromatographic curve obtained in the tenth elution stage shows a single wave peak.

A second object of the disclosure is to provide a sample analyzer including a first specimen supply device, a chromatographic separation device, and a first controller.

The first specimen supply device is configured to supply at least a first specimen and a second specimen to the chromatographic separation device, respectively.

The chromatographic separation device is controlled by the first controller to elute the first specimen and perform chromatographic analysis on a first solution to be detected that is obtained by eluting the first specimen, and to elute the second specimen and perform chromatographic analysis on a second solution to be detected that is obtained by eluting the second specimen.

The chromatographic separation device includes a chromatographic column, an eluent supply device and a first optical detection assembly.

The first specimen supply device is configured to supply at least the first specimen and the second specimen to the chromatographic column, respectively.

The eluent supply device is controlled by the first controller to prepare a first liquid and a second liquid into an eluent, and to supply eluents containing the second liquid with different concentrations to the chromatographic column respectively.

The chromatographic column is configured to elute the first specimen and the second specimen with the eluents respectively.

The first optical detection assembly is configured to perform the chromatographic analysis on the first solution to be detected that is obtained by eluting the first specimen in the chromatographic column and the second solution to be detected that is obtained by eluting the second specimen in the chromatographic column respectively.

The first controller is configured to: control the first specimen supply device to supply the first specimen to the chromatographic column; control the eluent supply device to prepare the first liquid and the second liquid into the eluents containing the second liquid with different concentrations according to a first concentration control mode and to supply the eluents containing the second liquid with different concentrations to the chromatographic column respectively, so as to elute the first specimen in the chromatographic column; and control the first optical detection assembly to perform the chromatographic analysis on the first solution to be detected that is obtained in the chromatographic column.

The first controller is further configured to: in response to determining that there is an interfering substance in the first specimen based on feedback information from the chromatographic separation device, control the first specimen supply device to supply the second specimen to the chromatographic separation device; control the eluent supply device to prepare the first liquid and the second liquid into the eluents containing the second liquid with different concentrations according to a second concentration control mode, and to supply the eluents containing the second liquid with different concentrations to the chromatographic column respectively, so as to elute the second specimen in the chromatographic column; and control the first optical detection assembly to perform the chromatographic analysis on the second solution to be detected that is obtained in the chromatographic column.

The first concentration control mode is different from the second concentration control mode.

In an implementation, the eluent supply device includes a mixing component, a first infusion power component and a second infusion power component.

The first infusion power component is configured to deliver the first liquid from a first container to the mixing component.

The second infusion power component is configured to deliver the second liquid from a second container to the mixing component.

The mixing component is configured to supply the eluents formed by at least one of the first liquid and the second liquid to the chromatographic column.

The first controller is further configured to control the mixing component to supply the eluents containing the second liquid with different concentrations to the chromatographic column by controlling operating parameters of the first infusion power component and the second infusion power component, respectively.

In an implementation, duration in which the eluent supply device supplies the eluent to the chromatographic column according to the first concentration control mode is shorter than duration in which the eluent supply device supplies the eluent to the chromatographic column according to the second concentration control mode.

In an implementation, the eluent supply device supplies the eluent to the chromatographic column according to the first concentration control mode during a first elution stage, a second elution stage and a third elution stage arranged in sequence, and the eluent supply device supplies the eluent to the chromatographic column according to the second concentration control mode during a fourth elution stage, a fifth elution stage and a sixth elution stage arranged in sequence.

The first elution stage and the fourth elution stage are used for eluting and analyzing glycosylated hemoglobin in the first specimen and glycosylated hemoglobin in the second specimen respectively. The second elution stage and the fifth elution stage are used for eluting and analyzing non-glycosylated hemoglobin in the first specimen and non-glycosylated hemoglobin in the second specimen respectively. The third elution stage is used for eluting and analyzing an interfering substance in the first specimen. The sixth elution stage is used for eluting and analyzing an interfering substance in the second specimen.

A concentration of the second liquid in an eluent used in the third elution stage is greater than a concentration of the second liquid in an eluent used in the first elution stage and greater than a concentration of the second liquid in an eluent used in the second elution stage.

A concentration of the second liquid in an eluent used in the sixth elution stage is greater than a concentration of the second liquid in an eluent used in the fourth elution stage and greater than a concentration of the second liquid in an eluent used in the fifth elution stage.

The eluents are prepared from at least one of the first liquid and the second liquid, and an ionic strength of the first liquid is less than an ionic strength of the second liquid.

In an implementation, the concentration of the second liquid in the eluent used in the second elution stage is greater than the concentration of the second liquid in the eluent used in the first elution stage.

The concentration of the second liquid in the eluent used in the fifth elution stage is greater than the concentration of the second liquid in the eluent used in the fourth elution stage.

In an implementation, the first elution stage transitions to the second elution stage in a time period close to the second elution stage with a tendency to gradually increase the concentration of the second liquid in the eluent, and the fourth elution stage transitions to the fifth elution stage in a time period close to the fifth elution stage with a tendency to gradually increase the concentration of the second liquid in the eluent.

The concentration of the second liquid in the eluent used in the time period, close to the second elution stage, in the first elution stage varies to a greater extent than the concentration of the second liquid in the eluent used in the time period, close to the fifth elution stage, in the fourth elution stage.

In an implementation, a concentration of the second liquid in an eluent used in a transition interval between the second elution stage and the third elution stage varies to a greater extent than a concentration of the second liquid in an eluent used in a transition interval between the fifth elution stage and the sixth elution stage.

In an implementation, duration of the fifth elution stage is longer than duration of the second elution stage; and/or, duration of the sixth elution stage is longer than duration of the third elution stage.

In an implementation, duration of the first elution stage is longer than duration of the second elution stage and longer than duration of the third elution stage.

In an implementation, the sample analyzer further includes a display.

The first controller is further configured to control the display to display a display interface including at least a chromatographic curve showing a glycosylated hemoglobin peak, a non-glycosylated hemoglobin peak and an interfering substance peak, after elution of the second specimen using the eluent made in the second concentration control mode and chromatographic analysis of the second solution to be detected that is obtained by eluting the second specimen by the chromatographic separation device are completed.

In an implementation, the sample analyzer further includes a display.

The first controller is further configured to control the display to display a display interface including at least a parameter of glycosylated hemoglobin in the second specimen and a parameter of an interfering substance in the second specimen, after elution of the second specimen using the eluent made in the second concentration control mode and chromatographic analysis of the second solution to be detected that is obtained by eluting the second specimen by the chromatographic separation device are completed.

A third object of the disclosure is to provide a sample analyzer including a first specimen supply device, a chromatographic separation device, and a first controller.

The first specimen supply device is configured to supply at least a first specimen and a second specimen to the chromatographic separation device, respectively.

The chromatographic separation device is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode.

The first controller is configured to: in response to determining that there is an interfering substance in the first specimen based on feedback information from the chromatographic separation device in the first operation mode, control the first specimen supply device to supply the second specimen to the chromatographic separation device, and to control the chromatographic separation device to elute the second specimen and to perform the chromatographic analysis on the second solution to be detected that is obtained by eluting the second specimen in the second operation mode.

A fourth object of the disclosure is to provide a sample analysis system including a sample management device, a first sample analyzer, a second sample analyzer, a transfer track and a second controller.

The sample management device is configured to at least place a sample container loaded with a sample.

The first sample analyzer is configured to aspirate the sample from the sample container to perform a glycosylated hemoglobin test item.

The second sample analyzer is configured to aspirate the sample from the sample container to perform a blood routine test item.

The transfer track extends from the sample management device to the first sample analyzer and the second sample analyzer.

The second controller is configured to control the transfer track to transfer the sample container to at least one of the first sample analyzer and the second sample analyzer.

The first sample analyzer includes a first specimen supply device, a chromatographic separation device and a first controller. The first specimen supply device is configured to aspirate the sample from the sample container to prepare a first specimen and supply the first specimen to the chromatographic separation device, and to aspirate the sample from the sample container to prepare a second specimen and supply the second specimen to the chromatographic separation device. The chromatographic separation device is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode.

The first controller is configured to analyze feedback information from the chromatographic separation device in the first operation mode to obtain a parameter of glycosylated hemoglobin in the first specimen and a conclusion as to whether there is an interfering substance in the first specimen. The first controller is further configured to analyze feedback information from the chromatographic separation device in the second operation mode to obtain a parameter of glycosylated hemoglobin in the second specimen and a parameter of an interfering substance in the second specimen.

In an implementation, the chromatographic separation device includes a chromatographic column, an eluent supply device, and a first optical detection assembly.

The first specimen supply device is configured to supply at least the first specimen and the second specimen to the chromatographic column, respectively.

The eluent supply device is controlled by the first controller to prepare a first liquid and a second liquid into an eluent, and to supply eluents containing the second liquid with different concentrations to the chromatographic column respectively.

The chromatographic column is configured to elute the first specimen and the second specimen with the eluents respectively.

The first optical detection assembly is configured to perform the chromatographic analysis on the first solution to be detected that is obtained by eluting the first specimen in the chromatographic column and the second solution to be detected that is obtained by eluting the second specimen in the chromatographic column respectively.

The first controller is further configured to control the eluent supply device to prepare the first liquid and the second liquid into the eluents containing the second liquid with different concentrations according to a first concentration control mode in the first operation mode, and to supply the eluents containing the second liquid with different concentrations to the chromatographic column respectively, so as to elute the first specimen in the chromatographic column.

The first controller is further configured to control the eluent supply device to prepare the first liquid and the second liquid into the eluents containing the second liquid with different concentrations according to a second concentration control mode in the second operation mode, and to supply the eluents containing the second liquid with different concentrations to the chromatographic column respectively, so as to elute the second specimen in the chromatographic column.

The first concentration control mode is different from the second concentration control mode.

In an implementation, the first controller is further configured to control the chromatographic separation device to elute the first specimen in the first operation mode and elute the second specimen in the second operation mode, using the same chromatographic column.

In an implementation, elution duration of the first specimen by the chromatographic separation device in the first operation mode is shorter than that of the second specimen by the chromatographic separation device in the second operation mode.

In an implementation, the first controller is further configured to: in response to determining that there is an interfering substance in the first specimen based on the feedback information from the chromatographic separation device in the first operation mode, control the first specimen supply device to supply the second specimen to the chromatographic separation device, and to control the chromatographic separation device to elute the second specimen and to perform the chromatographic analysis on the second solution to be detected that is obtained by eluting the second specimen in the second operation mode.

In an implementation, the first specimen supply device includes a first sample dispensing device, a first reagent dispensing device, a first reaction cell and a first specimen conveying device. The first sample dispensing device is configured to aspirate the sample from the sample container and dispense at least part of the aspirated sample into the first reaction cell. The first reagent dispensing device is configured to aspirate a reagent from a reagent container and dispense the aspirated reagent into the first reaction cell. The first reaction cell is configured to prepare the sample and the reagent into a specimen. The first specimen conveying device is configured to convey the specimen from the first reaction cell to the chromatographic separation device.

The first controller is configured to control the first specimen supply device to supply the second specimen to the chromatographic separation device by: controlling the first sample dispensing device to re-aspirate the sample from the sample container and dispense at least part of the re-aspirated sample into the first reaction cell, controlling the first reagent dispensing device to aspirate the reagent from the reagent container and dispense the aspirated reagent into the first reaction cell, controlling the first reaction cell to prepare the sample and the reagent into the second specimen, and controlling the first specimen conveying device to supply the second specimen to the chromatographic separation device.

In an implementation, the first sample analyzer further includes a display.

The first controller is further configured to control the display to display a display interface including at least a chromatographic curve showing a glycosylated hemoglobin peak, a non-glycosylated hemoglobin peak and an interfering substance peak, after elution of the second specimen and chromatographic analysis of the second solution to be detected that is obtained by eluting the second specimen by the chromatographic separation device in the second operation mode are completed.

In an implementation, the first sample analyzer further includes a display. The first controller is further configured to: in response to determining that there is the interfering substance in the first specimen based on the feedback information from the chromatographic separation device in the first operation mode, control the display to display a display interface including at least the parameter of the glycosylated hemoglobin in the first specimen and prompt information of presence of the interfering substance in the first specimen; and/or the first controller is further configured to: in response to determining that there is no interfering substance in the first specimen based on the feedback information from the chromatographic separation device in the first operation mode, control the display to display a display interface including at least the parameter of the glycosylated hemoglobin in the first specimen.

In an implementation, the sample analyzer further includes a display.

The first controller is further configured to: in response to determining that there is the interfering substance in the first specimen based on the feedback information from the chromatographic separation device in the first operation mode, control the display to display a display interface including at least prompt information of presence of the interfering substance in the first specimen and prompt information as to whether to switch to the second operation mode.

The first controller is further configured to: obtain an instruction for switching to the second operation mode, control the first specimen supply device to supply the second specimen to the chromatographic separation device, and control the chromatographic separation device to elute the second specimen and perform the chromatographic analysis on the second solution to be detected that is obtained by eluting the second specimen in the second operation mode.

In an implementation, the chromatographic separation device is further controlled by the first controller to elute a third specimen and perform chromatographic analysis on a third solution to be detected that is obtained by eluting the third specimen in a third operation mode.

The first controller is further configured to analyze feedback information from the chromatographic separation device in the third operation mode to obtain a parameter of glycosylated hemoglobin in the third specimen.

Elution duration of the third specimen by the chromatographic separation device in the third operation mode is shorter than that of the first specimen by the chromatographic separation device in the first operation mode.

The sample analyzer provided by the first object and the sample analysis system provided by the fourth object of the disclosure can control the chromatographic separation device by the first controller to carry out elution and chromatographic analysis on the first specimen in the first operation mode and the second specimen in the second operation mode respectively. The first controller can analyze and obtain the parameter of the glycosylated hemoglobin in the first specimen and the conclusion as to whether there is an interfering substance in the first specimen in the first operation mode, and can analyze and obtain the parameter of the glycosylated hemoglobin in the second specimen and the parameter of the interfering substance in the second specimen in the first operation mode, so that the accuracy of measurement data can be ensured by adopting the second operation mode and the measurement speed can be ensured by adopting the first operation mode. In addition, since the first controller can analyze and obtain the conclusion as to whether there is an interfering substance in the first specimen in the first operation mode, the situation that the user cannot determine which mode to use for testing when facing an unknown sample can be avoided, and the usability of the sample analyzer is improved.

The second object of the disclosure is to provide a sample analyzer. The first controller is arranged to control the eluent supply device to prepare the first liquid and the second liquid into the eluents containing the second liquid with different concentrations according to the first concentration control mode to elute and analyze the first specimen in the chromatographic column, and then to control the eluent supply device to prepare the first liquid and the second liquid into the eluents containing the second liquid with different concentrations according to the second concentration control mode to elute and analyze the second specimen in the chromatographic column, in response to determining that there is an interfering substance in the first specimen based on the feedback information from the chromatographic separation device. In this way, the eluent supplying scheme in the second concentration control mode can be adopted to ensure the accuracy of measurement data and the eluent supplying scheme in the first concentration control mode can be adopted to ensure the measurement speed, so that both the measurement speed and the accuracy can be taken into account. In addition, when the first specimen in the chromatographic column is eluted and analyzed by using the eluent prepared according to the first concentration control mode, if the first controller determines that there is an interfering substance in the first specimen based on the feedback information from the chromatographic separation device, the eluent supply device can be automatically controlled to prepare the first liquid and the second liquid into the eluents containing the second liquid with different concentrations according to the second concentration control mode for eluting and analyzing the second specimen in the chromatographic column, thereby avoiding the situation that the user cannot determine which mode to use for testing when facing an unknown sample, and improving the usability of the sample analyzer. The eluent supply device can use the first liquid and the second liquid to prepare eluents with different mixing ratios online according to the first concentration control mode and the second concentration control mode, so as to meet the eluent supplying demand for different measurements. Therefore, one set of eluents can be used to meet different eluent analysis requirements, which is conducive to reducing the quantity of materials and reducing the cost of using the sample analyzer for the user.

The sample analyzer provided by the third object of the disclosure can control the chromatographic separation device by the first controller to carry out elution and chromatographic analysis on the first specimen in the first operation mode and the second specimen in the second operation mode respectively, and if it is determined that there is an interfering substance in the first specimen based on the feedback information from the chromatographic separation device in the first operation mode, the first specimen supply device is controlled to supply the second specimen to the chromatographic separation device and the chromatographic separation device is controlled to carry out elution and chromatographic analysis on the second specimen in the second operation mode, so that the accuracy of measurement data can be ensured by adopting the second operation mode and the measurement speed can be ensured by adopting the first operation mode. In addition, since the first controller can analyze and obtain the conclusion as to whether there is an interfering substance in the first specimen in the first operation mode, the situation that the user cannot determine which mode to use for testing when facing an unknown sample can be avoided, and the usability of the sample analyzer is improved.

### BRIEF DESCRIPTION OF THE DRAWINGS

In order to explain more clearly the embodiments of the disclosure or the technical solutions of the related art, the drawings required to be used in the description of the embodiments or the related art will be briefly described below. It will be apparent that the drawings described below are only some embodiments of the disclosure, and other drawings may be obtained from the structure shown in these drawings without any creative effort by those of ordinary skill in the art.

FIG. 1 is a schematic diagram of a liquid path of a first sample analyzer in an elution state according to an embodiment of the disclosure.

FIG. 2 is a schematic diagram of a liquid path of a first sample analyzer in a specimen injection state according to an embodiment of the disclosure.

FIG. 3 is a schematic diagram of a liquid path of a chromatographic separation device according to an embodiment of the disclosure.

FIG. 4 is a schematic diagram of a concentration change of a second liquid in an eluent in a first operation mode according to an embodiment of the disclosure, where the abscissa is time in the unit of seconds, and the ordinate is a proportion of volume of the second liquid in the eluent, that is, a ratio of the volume of the second liquid to a total volume of the eluent (the total volume of the eluent is a sum of the volume of the second liquid and a volume of a first liquid).

FIG. 5 is a chromatographic curve obtained in a first operation mode when a first type of interfering substance exists in a first specimen according to an embodiment of the disclosure, where the abscissa is time in the unit of centiseconds, and the ordinate is spectral intensity in the unit of mOD.

FIG. 6 is a chromatographic curve obtained in a first operation mode when a second type of interfering substance exists in a first specimen according to an embodiment of the disclosure.

FIG. 7 is a chromatographic curve obtained in a first operation mode when a third type of interfering substance exists in a first specimen according to an embodiment of the disclosure.

FIG. 8 is a schematic diagram of a concentration change of a second liquid in an eluent in a second operation mode according to an embodiment of the disclosure, where the abscissa is time in the unit of seconds, and the ordinate is a proportion of volume of the second liquid in the eluent, that is, a ratio of the volume of the second liquid to a total volume of the eluent (the total volume of the eluent is a sum of the volume of the second liquid and a volume of a first liquid).

FIG. 9 is a chromatographic curve obtained in a second operation mode according to an embodiment of the disclosure.

FIG. 10 is a schematic diagram of a concentration change of a second liquid in an eluent in a third operation mode according to an embodiment of the disclosure, where the abscissa is time in the unit of seconds, and the ordinate is a proportion of volume of the second liquid in the eluent, that is, a ratio of the volume of the second liquid to a total volume of the eluent (the total volume of the eluent is a sum of the volume of the second liquid and a volume of a first liquid).

FIG. 11 is a chromatographic curve obtained in a third operation mode according to an embodiment of the disclosure.

FIG. 12 is a structural diagram of a sample analysis system according to an embodiment of the disclosure.

FIG. 13 is a schematic diagram of the composition of a sample analysis system according to an embodiment of the disclosure.

FIG. 14 is a schematic diagram of the composition of a second sample analyzer according to an embodiment of the disclosure.

FIG. 15 is a schematic diagram of a liquid path of a second sample analyzer according to an embodiment of the disclosure.

Description of the reference numbers: 1, sample analysis system; 10, first sample analyzer; 100, chromatographic separation device; 110, chromatographic column; 120, eluent supply device; 121, mixing component; 122, first infusion power component; 123, second infusion power component; 124, first container; 125, second container; 130, first optical detection assembly; 200, first specimen supply device; 20, second sample analyzer; 21, second sample dispensing device; 22, second reagent dispensing device; 23, second optical detection assembly; 2301, second reaction cell; 2302, flow chamber; 2303, optical detection component; 2304, first sample preparation pipeline; 2305, sheath fluid pipeline; 24, hemoglobin detection assembly; 2401, hemoglobin detection cell; 2402, hemoglobin detection element; 25, impedance detection assembly; 2501, impedance detection cell; 2502, impedance detector; 2503, second sample preparation pipeline; 26, third controller; 30, sample management device; 40, transfer track; 50, second controller.

### DETAILED DESCRIPTION

The technical solutions in the embodiments of the disclosure will be clearly and completely described below in conjunction with the accompanying drawings in the embodiments of the disclosure. It will be apparent that the described embodiments are only part of the embodiments of the disclosure, and not all of the embodiments. All other embodiments obtained by those of ordinary skill in the art based on the embodiments in the disclosure without creative effort shall fall within the scope of protection of the disclosure.

It should be noted that all directivity indications (such as up, down, left, right, front, back, etc.) in the embodiment of the disclosure are only used to explain a relative positional relationship and motion among the components in a specific posture, and if the specific posture is changed, the directivity indications are changed accordingly.

It should also be noted that when an element is said to be “fixed” or “arranged” on another element, it may be directly on the other element or may be accompanied by an intervening element. When an element is said to be “connected” to another element, it may be directly connected to another element or it may be indirectly connected to another element thorough an intervening element.

In addition, the descriptions in the disclosure relating to “first”, “second” and the like are for descriptive purposes only and cannot be construed as indicating or implying their relative importance or implying the number of technical features indicated. Thus, the features defined as “first”, “second” may explicitly or implicitly include at least one of the features. In addition, the technical solutions in the various embodiments may be combined with each other on the basis that the person of ordinary skill in the art can implement it. When the technical solutions conflicts with each other or the combination cannot be implemented, it should be considered that the combination of the technical solutions does not exist and is not within the scope of protection of the disclosure.

### First Embodiment

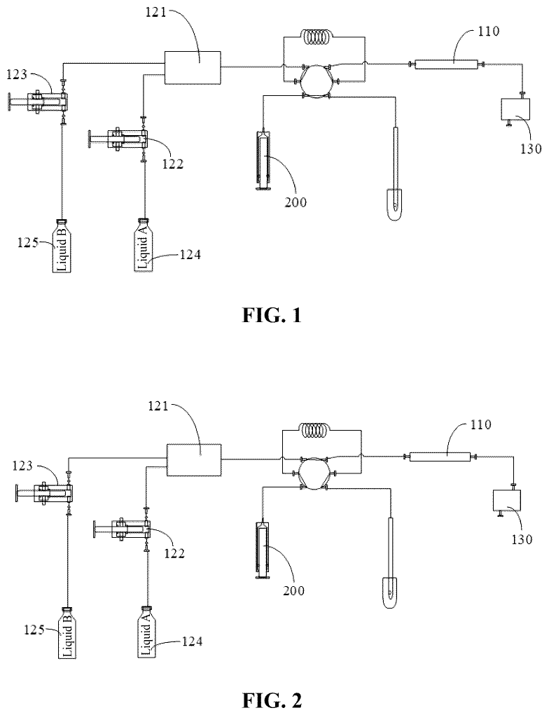

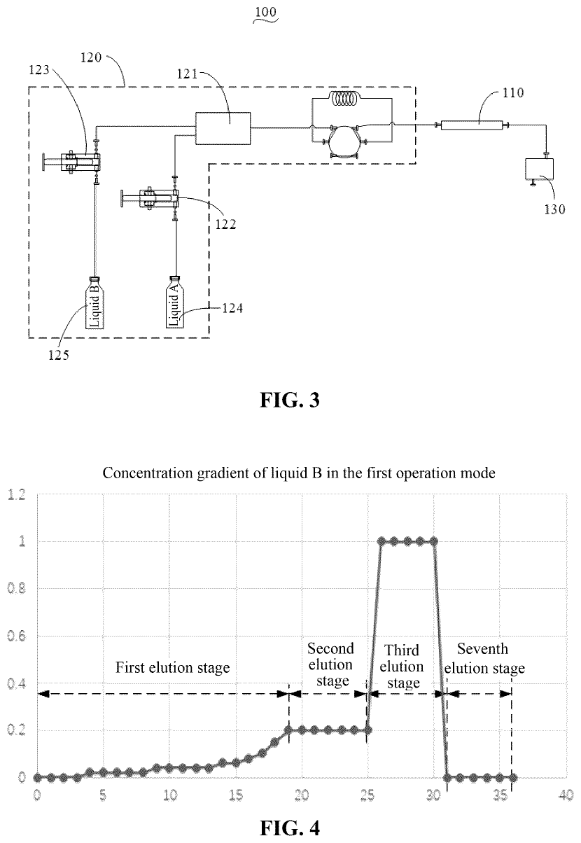

As shown in FIGS. 1 to 11, a first sample analyzer 10 provided in the first embodiment of the disclosure includes a first specimen supply device 200, a chromatographic separation device 100 and a first controller. The first specimen supply device 200 is configured to supply a specimen to the chromatographic separation device 100. The chromatographic separation device 100 is controlled by the first controller to elute the specimen and perform chromatographic analysis on a solution to be detected that is obtained by eluting the specimen.

In an implementation, the first sample analyzer 10 has a first operation mode and a second operation mode. The first specimen supply device 200 is configured to supply at least a first specimen and a second specimen to the chromatographic separation device 100, respectively, that is, the first specimen supply device 200 is configured to supply at least the first specimen to the chromatographic separation device 100 and the second specimen to the chromatographic separation device 100, respectively. The chromatographic separation device 100 is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode. The first specimen and the second specimen are made of samples in the same sample container. The first controller is configured to analyze feedback information from the chromatographic separation device 100 in the first operation mode to obtain a parameter of glycosylated hemoglobin in the first specimen and a conclusion as to whether there is an interfering substance in the first specimen. The first controller is further configured to analyze feedback information from the chromatographic separation device 100 in the second operation mode to obtain a parameter of the glycosylated hemoglobin in the second specimen and a parameter of the interfering substance in the second specimen. The first operation mode is used for quickly detecting the parameter of the glycosylated hemoglobin in the first specimen and determining whether there is an interfering substance, and if there is no interfering substance, the detection result of the first operation mode may be output as a measurement result of the glycosylated hemoglobin in the sample. If the first controller determines that there is an interfering substance in the first specimen based on the detection result of the first operation mode, it is determined that measurement data of the first operation mode is inaccurate. At this time, the second operation mode may be adopted to re-elute and analyze the sample. Because the first controller can obtain the parameter of the interfering substance based on the measurement data of the second operation mode, the parameter of the glycosylated hemoglobin in the sample can be accurately analyzed, and the accuracy of the measurement data can be ensured. In specific application, the first operation mode may be used to ensure a measurement speed, and the second operation mode may be used to ensure the accuracy of the measurement data. In addition, since the first controller can analyze and obtain the conclusion as to whether there is an interfering substance in the first specimen in the first operation mode, the situation that the user cannot determine which mode to use for testing when facing an unknown sample can be avoided, and a usability of the sample analyzer is improved.

In an implementation, the first operation mode is a default operation mode of the first sample analyzer 10, and the first sample analyzer 10 elutes and analyzes the first specimen in the first operation mode by default in the case of no user intervention and selection, to ensure the measurement speed of the glycosylated hemoglobin of most samples.

In an implementation, the chromatographic separation device 100 includes a chromatographic column 110, an eluent supply device 120 and a first optical detection assembly 130. The first specimen supply device 200 is configured to supply at least the first specimen and the second specimen to the chromatographic column 110 respectively, that is, the first specimen supply device 200 is configured to supply the first specimen to the chromatographic column 110 and supply the second specimen to the chromatographic column 110. The eluent supply device 120 is configured to supply an eluent to the chromatographic column 110. The chromatographic column 110 is configured to elute the first specimen with the eluent and elute the second specimen with the eluent. The first optical detection assembly 130 is configured to perform chromatographic analysis on a first solution to be detected that is obtained by eluting the first specimen in the chromatographic column 110 and perform the chromatographic analysis on a second solution to be detected that is obtained by eluting the second specimen in the chromatographic column 110, respectively.

In an implementation, there is one eluent supply device 120 and the first and second operation modes share the same eluent supply device 120 to supply the eluent. The first controller is configured to control the chromatographic separation device 100 to supply the eluent to the chromatographic column 110 in the first operation mode and the second operation mode respectively, using the same eluent supply device 120.

In an implementation, the eluent supply device 120 is controlled by the first controller to prepare the eluent into eluents with different concentrations on line, to meet the elution requirements in the first operation mode and the second operation mode. In this implementation, the eluent analysis requirements of different operation modes can be met by using one kind of eluent, and the material quantity and material cost can be reduced.

In an implementation, the eluent supply device 120 is controlled by the first controller to prepare a first liquid and a second liquid into the eluent and to supply the eluents containing the second liquid with different concentrations to the chromatographic column 110 respectively, that is, the eluent supply device 120 may be controlled by the first controller to prepare the eluents with different mixing ratios from the first liquid and the second liquid and supply them to the chromatographic column 110.

In an implementation, an ionic strength of the first liquid is less than an ionic strength of the second liquid. The first liquid may be specifically liquid A, and the second liquid may be specifically liquid B.

In an implementation, the first controller is further configured to control the eluent supply device 120 to prepare the first liquid and the second liquid into eluents containing the second liquid with different concentrations according to a first concentration control mode in the first operation mode, and supply the eluents containing the second liquid with different concentrations to the chromatographic column 110 respectively, so as to elute the first specimen in the chromatographic column 110. The first controller is further configured to control the eluent supply device 120 to prepare the first liquid and the second liquid into eluents containing the second liquid with different concentrations according to a second concentration control mode in the second operation mode, and supply the eluents containing the second liquid with different concentrations to the chromatographic column 110 respectively, so as to elute the second specimen in the chromatographic column 110. The first concentration control mode is different from the second concentration control mode. The difference between the first concentration control mode and the second concentration control mode mainly refers to a difference in the way of preparing the eluent online between the first operation mode and the second operation mode in the elution analysis process. In the first operation mode and the second operation mode, the eluent consisting of the first liquid and the second liquid is used, and only the mixing ratio of the first liquid to the second liquid is adjusted and controlled differently, so that the material quantity and the material cost are effectively reduced. In the implementation, the eluent is prepared online, and the mixing ratio is adjusted and controlled in real time by the first controller.

In an implementation, there is one chromatographic column 110. The first controller is further configured to control the chromatographic separation device 100 to perform the elution of the first specimen in the first operation mode and the elution of the second specimen in the second operation mode respectively, using the same chromatographic column 110, i.e. the elution of the first specimen in the first operation mode and the elution of the second specimen in the second operation mode are performed using the same chromatographic column 110. In the implementation, one chromatographic column 110 and one kind of eluent can meet the elution analysis requirements of the first specimen in the first operation mode and the second specimen in the second operation mode, and the material quantity is small and the material cost is low.

In an implementation, the eluent supply device 120 includes a mixing component 121, a first infusion power component 122 for delivering the first liquid from a first container 124 to the mixing component 121, and a second infusion power component 123 for delivering the second liquid from a second container 125 to the mixing component 121. The mixing component 121 is configured to supply the eluent formed from the first liquid and/or the second liquid to the chromatographic column 110. The first controller is further configured to control the mixing component 121 to supply the eluents containing the second liquid with different concentrations to the chromatographic column 110 by controlling operating parameters of the first infusion power component 122 and the second infusion power component 123, respectively.

In an implementation, the first infusion power component 122 may be a pump or a syringe.

In an implementation, the second infusion power component 123 may be a pump or a syringe.

In an implementation, elution duration of the first specimen by the chromatographic separation device 100 in the first operation mode is shorter than that of the second specimen by the chromatographic separation device 100 in the second operation mode, so that the design requirement of the first sample analyzer 10 for rapid measurement of the glycosylated hemoglobin can be met by adopting the first operation mode, and the design requirement of the first sample analyzer 10 for accurate measurement of the glycosylated hemoglobin can be met by adopting the second operation mode.

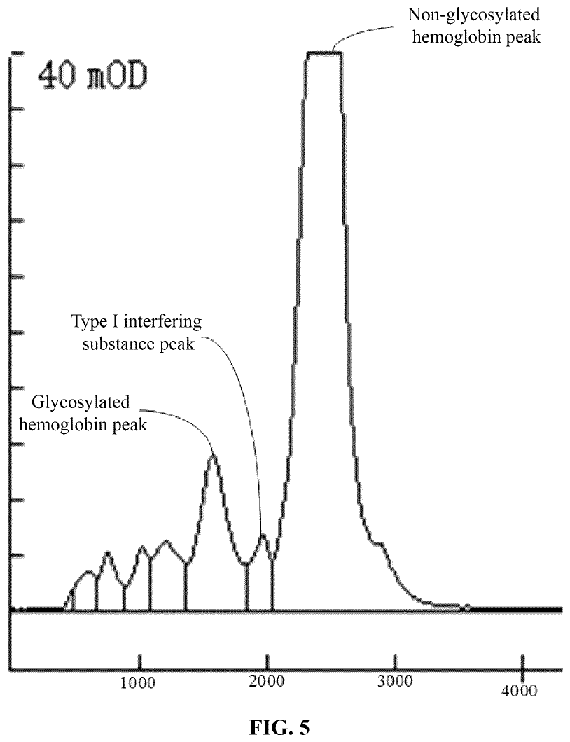

Referring to FIG. 4, in an implementation, the first operation mode includes a first elution stage, a second elution stage and a third elution stage arranged in sequence. The first elution stage is used for eluting and analyzing the glycosylated hemoglobin in the first specimen, and the eluting and analyzing may be performed to form a glycosylated hemoglobin peak in a chromatographic curve. The second elution stage is used for eluting and analyzing the non-glycosylated hemoglobin in the first specimen, and the eluting and analyzing may be performed to form at least a non-glycosylated hemoglobin peak in the chromatographic curve. The third elution stage is used for eluting the interfering substance in the first specimen.

In an implementation, the first controller is further configured to analyze the feedback information from the chromatographic separation device 100 to obtain the chromatographic curve in the first operation mode, and to determine that there is an interfering substance in the first specimen if more than two peaks are formed in the chromatographic curve obtained by analysis in the second elution stage and the third elution stage. Specifically, when the interfering substance exists in the first specimen, more than two peaks are formed by analysis in the second elution stage and the third elution stage, one of which is the non-glycosylated hemoglobin peak and the other are interfering substance peaks.

In an implementation, the first controller is further configured to analyze the feedback information from the chromatographic separation device 100 to obtain the chromatographic curve in the second operation mode. The chromatographic curve obtained by analysis in the fifth elution stage and the sixth elution stage shows more than two peaks. In the fifth and sixth elution stages, more than two peaks are formed, one of which is the non-glycosylated hemoglobin peak and the other are interfering substance peaks.

In an implementation, an interval between two adjacent peaks in the peaks formed in the fifth elution stage and the sixth elution stage is longer than an interval between two adjacent peaks in the peaks formed in the second elution stage and the third elution stage.

Referring to FIG. 4, in an implementation, a concentration of the second liquid in the eluent employed in the third elution stage is greater than a concentration of the second liquid in the eluent employed in the first elution stage and greater than a concentration of the second liquid in the eluent employed in the second elution stage. In FIG. 4, liquid B is the second liquid. In the figure, the concentration of the second liquid is represented by a volume ratio of the second liquid in the eluent, that is, the ordinate in FIG. 4 is a ratio of a volume of the second liquid to a total volume of the eluent (the total volume of the eluent is the sum of the volume of the second liquid and a volume of the first liquid). For example, the ordinate of 0 indicates that the volume ratio of the second liquid in the eluent is 0, that is, the ratio of the volume of the second liquid to the total volume of the eluent is 0, and the eluent is made of the first liquid only. The ordinate of 0.2 indicates that the volume ratio of the second liquid in the eluent is 0.2, that is, the ratio of the volume of the second liquid to the total volume of the eluent is 0.2, and the second liquid and the first liquid are mixed in the ratio of 2:8 (volume ratio) to prepare the eluent. The ordinate of 0.4 indicates that the volume ratio of the second liquid in the eluent is 0.4, that is, the ratio of the volume of the second liquid to the total volume of the eluent is 0.4, and the second liquid and the first liquid are mixed in the ratio of 4:6 (volume ratio) to prepare the eluent. The ordinate of 0.6 indicates that the volume ratio of the second liquid in the eluent is 0.6, that is, the ratio of the volume of the second liquid to the total volume of the eluent is 0.6, and the second liquid and the first liquid are mixed in the ratio of 6:4 (volume ratio) to prepare the eluent. The ordinate of 0.8 indicates that the volume ratio of the second liquid in the eluent is 0.8, that is, the ratio of the volume of the second liquid to the total volume of the eluent is 0.8, and the second liquid and the first liquid are mixed in the ratio of 8:2 (volume ratio) to prepare the eluent. The ordinate of 1 indicates that the volume ratio of the second liquid in the eluent is 1, that is, the ratio of the volume of the second liquid to the total volume of the eluent is 1, and the eluent is made of the second liquid only.

In an implementation, the concentration of the second liquid in the eluent employed in the second elution stage is greater than the concentration of the second liquid in the eluent employed in the first elution stage.

In an implementation, the first elution stage transitions to the second elution stage in a time period close to the second elution stage with a tendency to gradually increase the concentration of the second liquid in the eluent.

In an implementation, duration of the first elution stage is longer than duration of the second elution stage and longer than duration of the third elution stage.

In an implementation, the concentration of the second liquid in the eluent in the third elution stage is 1, i.e. the ratio of the volume of the second liquid to the total volume of the eluent is 1, and the eluent is made of the second liquid only.

In an implementation, the first operation mode further includes a seventh elution stage, which is arranged after the third elution stage and used to elute other components of the first specimen remaining in the chromatographic column 110 to avoid interference with measurement data of the next specimen.

In an implementation, the concentration of the second liquid in the eluent in the seventh elution stage is 0, that is, the volume ratio of the second liquid in the eluent is 0, and the eluent is made of the first liquid only.

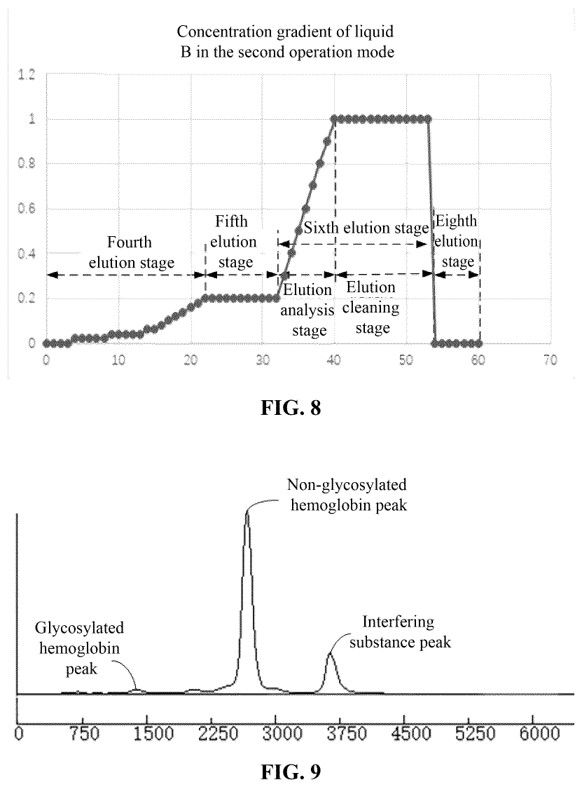

Referring to FIG. 8 in an implementation the second operation mode includes a fourth elution stage, a fifth elution stage and a sixth elution stage arranged in sequence. The fourth elution stage is used for eluting and analyzing the glycosylated hemoglobin in the second specimen, and the eluting and analyzing are performed to form a glycosylated hemoglobin peak in the chromatographic curve. The fifth elution stage is used for eluting and analyzing the non-glycosylated hemoglobin in the second specimen, and the eluting and analyzing are performed to form a non-glycosylated hemoglobin peak in the chromatographic curve. The sixth elution stage is used for eluting and analyzing the interfering substance in the second specimen, and the eluting and analyzing are performed to form an interfering substance peak in the chromatographic curve.

In an implementation, a concentration of the second liquid in an eluent employed in the sixth elution stage is greater than a concentration of the second liquid in an eluent employed in the fourth elution stage and greater than a concentration of the second liquid in an eluent employed in the fifth elution stage.

In an implementation, the sixth elution stage includes an elution analysis stage for eluting and analyzing the interfering substance in the second specimen, which can form the interfering substance peak in the chromatographic curve by the eluting and analyzing, and an elution cleaning stage for eluting and cleaning the interfering substance in the chromatographic column 110.

In an implementation, the concentration of the second liquid in the eluent in the elution analysis stage increases linearly, i.e. the concentration of the second liquid in the eluent increases gradually.

In an implementation, the concentration of the second liquid in the eluent in the elution cleaning stage is 1, that is, the ratio of the volume of the second liquid to the total volume of the eluent is 1, and the eluent is made of the second liquid only.

In an implementation, the second operation mode further includes an eighth elution stage, which is arranged after the elution cleaning stage of the sixth elution stage and used to elute other components of the second specimen remaining in the chromatographic column 110 to avoid interference with measurement data of the next specimen.

In an implementation, a concentration of the second liquid in the eluent in the eighth elution stage is 0, that is, the volume ratio of the second liquid in the eluent is 0, and the eluent is made of the first liquid only.

In an implementation, the concentration of the second liquid in the eluent employed in the fifth elution stage is greater than the concentration of the second liquid in the eluent employed in the fourth elution stage.

In an implementation, the fourth elution stage transitions to the fifth elution stage in a time period close to the fifth elution stage with a tendency to gradually increase the concentration of the second liquid in the eluent.

In an implementation, the concentration of the second liquid in the eluent employed in the first elution stage in a time period close to the second elution stage varies to a greater extent (i.e., gradient) than the concentration of the second liquid in the eluent employed in the fourth elution stage in a time period close to the fifth elution stage. In the implementation, the concentration of the second liquid rises more slowly in the second operation mode at an end of the elution phase for the glycosylated hemoglobin, to fully present the peak of the first type of interfering substances (e.g. Gly-HbE peak).

In an implementation, the concentration of the second liquid in the eluent employed in a transition interval between the second elution stage and the third elution stage varies to a greater extent (i.e. gradient) than the concentration of the second liquid in the eluent employed in a transition interval between the fifth elution stage and the sixth elution stage, so as to prevent a variant peak from being affected by a system peak caused by a sudden concentration change on the one hand, and to differentiate multi-variant samples as much as possible on the other hand. The transition interval between the fifth elution stage and the sixth elution stage is the elution analysis stage of the sixth elution stage.

In an implementation, duration of the fifth elution stage is longer than duration of the second elution stage.

In an implementation, duration of the sixth elution stage is longer than duration of the third elution stage.

In an implementation, the first controller is further configured to control the first specimen supply device 200 to supply the second specimen to the chromatographic separation device 100, and to control the chromatographic separation device 100 to elute the second specimen and to perform chromatographic analysis on the second solution to be detected that is obtained by eluting the second specimen in the second operation mode, if it is determined that there is an interfering substance in the first specimen based on the feedback information from the chromatographic separation device 100 in the first operation mode. With this control mode, an automation degree of the first sample analyzer 10 can be improved, and on the premise of ensuring the accuracy of measurement data, the user can have no sense of selecting the measurement mode during a measurement and analysis process using the first sample analyzer 10, thereby avoiding the situation that the user cannot determine which mode to use for testing when facing an unknown sample.

In an implementation, the first specimen supply device 200 includes a first sample dispensing device, a first reagent dispensing device, a first reaction cell and a first specimen conveying device. The first sample dispensing device is configured to aspirate a sample from a sample container and dispense at least part of the aspirated sample into the first reaction cell. The first reagent dispensing device is configured to aspirate a reagent from a reagent container and dispense the reagent into the first reaction cell. The first reaction cell is configured to prepare the sample and the reagent into the specimen (e.g. prepare the first specimen and the second specimen as described above, respectively). The first specimen conveying device is configured to convey the specimen from the first reaction cell to the chromatographic separation device 100. The first controller is configured to control the first specimen supply device 200 to supply the second specimen to the chromatographic separation device 100 by: controlling the first sample dispensing device to re-aspirate the sample from the sample container and dispense at least part of the re-aspirated sample into the first reaction cell, controlling the first reagent dispensing device to aspirate the reagent from the reagent container and dispense the reagent into the first reaction cell, controlling the first reaction cell to prepare the sample and the reagent into the second specimen, and controlling the first specimen supply device 200 to supply the second specimen to the chromatographic separation device 100. It should be noted that when preparing the first specimen or the second specimen in the first reaction cell, the dispensing sequence of the sample and the reagent is not limited, that is, the first sample dispensing device can be controlled to re-aspirate the sample from the sample container and dispense at least part of the re-aspirated sample into the first reaction cell, and then the first reagent dispensing device can be controlled to aspirate the reagent from the reagent container and dispense it into the first reaction cell; and it is also possible that the first reagent dispensing device is controlled to aspirate the reagent from the reagent container and dispense the reagent into the first reaction cell, and then the first sample dispensing device is controlled to re-aspirate the sample from the sample container and dispense at least part of the re-aspirated sample into the first reaction cell.

In an implementation, the first sample analyzer 10 further includes a display. The first controller is further configured to control the display to display a display interface including at least the chromatographic curve showing the glycosylated hemoglobin peak, the non-glycosylated hemoglobin peak and the interfering substance peak (as shown in FIG. 9) after elution and chromatographic analysis of the second specimen by the chromatographic separation device 100 in the second operation mode are completed. In the implementation, after the execution of the second operation mode is completed, the chromatographic curve displayed by the display may completely display shapes and positions of the glycosylated hemoglobin peak, the non-glycosylated hemoglobin peak and the interfering substance peak.

In an implementation, the first controller is further configured to control the display to display a display interface including at least the parameter of the glycosylated hemoglobin in the second specimen and the parameter of the interfering substance in the second specimen, after the elution of the second specimen and chromatographic analysis of the second solution to be detected that is obtained after eluting the second specimen by the chromatographic separation device 100 in the second operation mode are completed. In the implementation, not only the accurate measurement data of the glycosylated hemoglobin can be obtained, but also the measurement data of the interfering substance can be obtained by adopting the second operation mode.

In an implementation, the first controller is further configured to control the display to display a display interface including at least the parameter of the glycosylated hemoglobin in the first specimen and prompt information of the presence of the interfering substance in the first specimen, if it is determined that there is the interfering substance in the first specimen based on the feedback information from the chromatographic separation device 100 in the first operation mode. In the implementation, after the completion of the first operation mode, the prompt information of the interfering substance will be displayed, which is convenient for an operator to intuitively obtain the information of the existence of the interfering substance.

In an implementation, the first controller is further configured to control the display to display a display interface including at least prompt information of the presence of the interfering substance in the first specimen and prompt information as to whether to switch to the second operation mode, if it is determined that there is the interfering substance in the first specimen based on the feedback information from the chromatographic separation device 100 in the first operation mode. The first controller is further configured to obtain an instruction for switching to the second operation mode, control the first specimen supply device 200 to supply the second specimen to the chromatographic separation device 100, and control the chromatographic separation device 100 to elute the second specimen and perform chromatographic analysis on the second solution to be detected that is obtained by eluting the second specimen in the second operation mode. The prompt information as to whether to switch to the second operation mode is mainly used for prompting the operator whether to switch to the second operation mode. The instruction for switching to the second operation mode may be generated by the operator inputting information through a man-machine interaction device.

In an implementation, the first controller is further configured to control the display to display a display interface including at least the parameter of the glycosylated hemoglobin in the first specimen, if it is determined that there is no interfering substance in the first specimen based on the feedback information from the chromatographic separation device 100 in the first operation mode.

In an implementation, the first controller is further configured to control the display to display a power-on interface including at least a selectable first operation mode and a selectable second operation mode.

In an implementation, the chromatographic separation device 100 is further controlled by the first controller to elute a third specimen and perform chromatographic analysis on a third solution to be detected that is obtained by eluting the third specimen in a third operation mode. The first controller is configured to analyze feedback information from the chromatographic separation device 100 in the third operation mode to obtain a parameter of the glycosylated hemoglobin in the third specimen. Elution duration of the third specimen by the chromatographic separation device 100 in the third operation mode is shorter than that of the first specimen by the chromatographic separation device 100 in the first operation mode. The third operation mode is a glycosylated hemoglobin measurement mode which is faster than the first operation mode.

In an implementation, the first controller is further configured to control the display to display a display interface including at least a selectable first operation mode, a selectable second operation mode, and a selectable third operation mode.

In an implementation, the first controller is configured to control the chromatographic separation device 100 to supply the eluent to the chromatographic column 110 in the first operation mode, the second operation mode and the third operation mode respectively by using the same eluent supply device 120.

In an implementation, the first controller is further configured to control the eluent supply device 120 to prepare the first liquid and the second liquid into eluents containing the second liquid with different concentrations according to a first concentration control mode in the first operation mode, and to supply the eluents containing the second liquid with different concentrations to the chromatographic column 110 respectively, so as to elute the first specimen in the chromatographic column 110. The first controller is further configured to control the eluent supply device 120 to prepare the first liquid and the second liquid into eluents containing the second liquid with different concentrations according to a second concentration control mode in the second operation mode, and to supply the eluents containing the second liquid with different concentrations to the chromatographic column 110 respectively, so as to elute the second specimen in the chromatographic column 110. The first controller is further configured to control the eluent supply device 120 to prepare the first liquid and the second liquid into eluents containing the second liquid with different concentrations according to a third concentration control mode in the third operation mode, and to supply the eluents containing the second liquid with different concentrations to the chromatographic column 110 respectively, so as to elute the third specimen in the chromatographic column 110. The first concentration control mode, the second concentration control mode and the third concentration control mode are different from one another.

In an implementation, the first controller is further configured to control the chromatographic separation device 100 to execute elution of the specimens in the first operation mode, the second operation mode and the third operation mode respectively by using the same chromatographic column 110. That is, the chromatographic column 110 is configured to elute the first specimen, the second specimen and the third specimen with the eluent, respectively. The first optical detection assembly 130 performs chromatographic analysis on the first solution to be detected that is obtained by eluting the first specimen in the chromatographic column 110, the second solution to be detected that is obtained by eluting the second specimen in the chromatographic column 110, and the third solution to be detected that is obtained by eluting the third specimen in the chromatographic column 110, respectively.

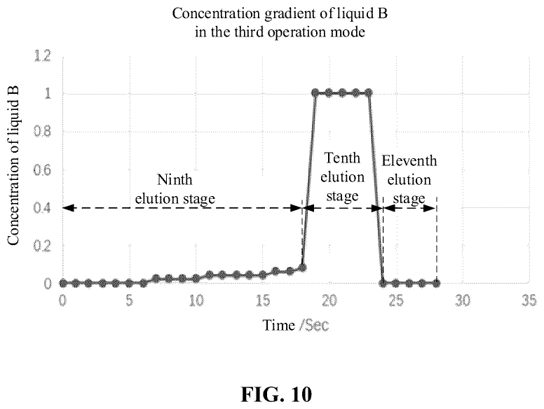

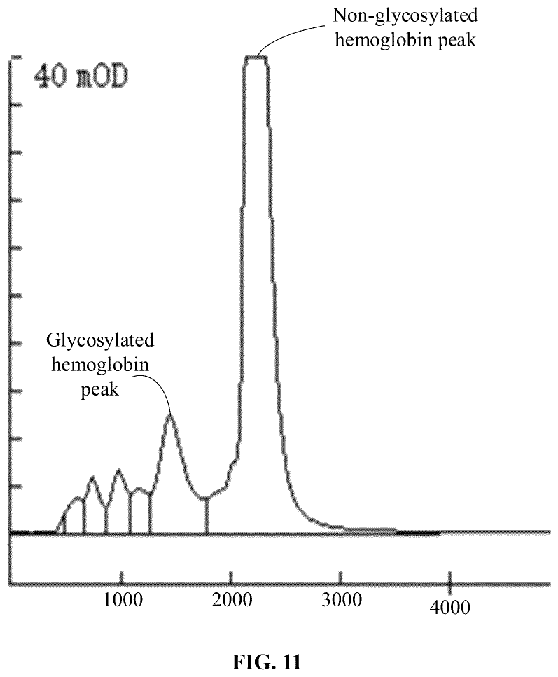

Referring to FIG. 10, in an implementation, the third operation mode includes a ninth elution stage, a tenth elution stage, and an eleventh elution stage arranged in sequence. The ninth elution stage is used for eluting and analyzing glycosylated hemoglobin in the third specimen, and the eluting and analyzing are performed to form a glycosylated hemoglobin peak in a chromatographic curve. The tenth elution stage is used for eluting and analyzing non-glycosylated hemoglobin and interfering substance in the third specimen, and the eluting and analyzing are performed to form a non-glycosylated hemoglobin peak containing the interfering substance in the chromatographic curve. The eleventh elution stage is used for eluting other components of the third specimen remaining in the chromatographic column 110 to avoid interference with measurement data of the next specimen.

In an implementation, the first controller is further configured to analyze the feedback information from the chromatographic separation device 100 to obtain the chromatographic curve in the third operation mode. The chromatographic curve obtained by analysis in the tenth elution stage shows a single wave peak.

In an implementation, a concentration of the second liquid in the eluent employed in the tenth elution stage is greater than a concentration of the second liquid in the eluent employed in the ninth elution stage and greater than a concentration of the second liquid in the eluent employed in the eleventh elution stage.

In an implementation, duration of the ninth elution stage is longer than duration of the tenth elution stage and longer than duration of the eleventh elution stage.

In an implementation, the concentration of the second liquid in the eluent in the tenth elution stage is 1, that is, the ratio of the volume of the second liquid to the total volume of the eluent is 1, and the eluent is made of the second liquid only.

In an implementation, the concentration of the second liquid in the eluent in the eleventh elution stage is 0, that is, the volume ratio of the second liquid in the eluent is 0, and the eluent is made of the first liquid only.

The embodiment provides a solution for taking into account the requirements on accuracy and speed. The fast mode (that is, the first operation mode) is fast and capable of prompting the presence of the variant. The variant mode (i.e. the second operation mode) is capable of recognizing a type of the variant and accurately reporting HbA1c.

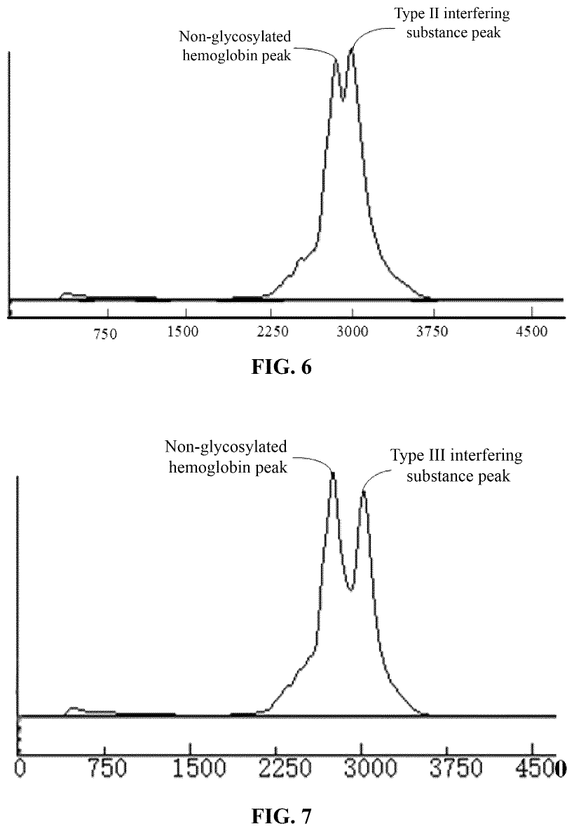

In an implementation, FIG. 5 is a chromatographic curve obtained in the first operation mode when a first type of interfering substance (e.g. the variant Gly-HbE) exists in the first specimen; FIG. 6 is a chromatographic curve obtained in the first operation mode when a second type of interfering substance (e.g. variant D) exists in the first specimen; and FIG. 7 is a chromatographic curve obtained in the first operation mode when a third type of interfering substance (e.g. variant S) exists in the first specimen.

In an implementation, an operating principle of the first sample analyzer 10 provided in the embodiment is as follows.
(1) A principle of the first operation mode is that the first operation mode is implemented by gradient elution, which specifically means that the concentration of the primary component of the eluent (i.e., the concentration of the second liquid) varies in gradients. In the first operation mode, the peaks of HbA1a, HbA1b, HbF, HbLA1c and HbSA1c are compressed by gradient elution, which saves time and keeps good resolution. The gradient elution can quickly elute Gly-HbE between HbA0 and HbLA1c. HbA0 peak is separated from HbD, HbS, HbC and other variants using an eluent with lower concentration. The variants are then quickly eluted using an eluent with high concentration (the eluent with a high concentration of the second liquid) without distinguishing the variants.
(2) A principle of the second operation mode is that the second operation mode is mainly used to accurately quantify the content and type of variants. The difference between the second operation mode and the first operation mode in elution scheme is mainly to completely show the peak shape and peak position of the variants.
(3) The difference in elution scheme between the second operation mode and the first operation mode includes: at the end of the elution stage of glycosylated hemoglobin, the concentration of the second liquid rises more slowly in the second operation mode, which is mainly for the complete presentation of Gly-HbE peak; the elution duration of HbA0 peak in the second operation mode is longer, which is mainly for complete separation of HbA0 peak from a variant peak; after that, the concentration changed slowly, so as to prevent the variant peak from being affected by a system peak caused by a sudden concentration change on the one hand, and to differentiate multi-variant samples as much as possible on the other hand.
(4) Variant prompting can be realized in the first operation mode. HbA0 can be separated from variant proteins such as HbE, HbD, HbS and HbC by gradient elution method based on the characteristics that an isoelectric point of variant proteins such as HbE, HbD, HbS and HbC exceeds 7.0, while an isoelectric point of HbA0 is about 6.9. In order to improve the measurement speed, HbE, HbD, HbS, HbC, etc. are regarded as variant groups in this embodiment, and every variant or variant combination is eluted to form a peak, that is, variant peak.

### Second Embodiment

A difference between a first sample analyzer 10 provided in this embodiment and the sample analyzer in the first embodiment mainly lies in a different protection emphasis, which is embodied in the following aspects: the first embodiment focuses on the protection of the detection results of the first operation mode and the second operation mode; whereas this embodiment focuses on the protection of a set of eluents to be made into different concentrations of eluents on-line by using the eluent supply device 120 to satisfy the demand for different concentrations of eluents.

Specifically, the first sample analyzer 10 provided in this embodiment includes a first specimen supply device 200, a chromatographic separation device 100 and a first controller. The first specimen supply device 200 is configured to supply at least a first specimen and a second specimen to the chromatographic separation device 100, respectively. The chromatographic separation device 100 is controlled by the first controller to elute the first specimen and perform chromatographic analysis on a first solution to be detected that is obtained by eluting the first specimen, and to elute the second specimen and perform chromatographic analysis on a second solution to be detected that is obtained by eluting the second specimen. The chromatographic separation device 100 includes a chromatographic column 110, an eluent supply device 120 and a first optical detection assembly 130. The first specimen supply device 200 is configured to supply at least the first specimen and the second specimen to the chromatographic column 110, respectively. The eluent supply device 120 is controlled by the first controller to prepare a first liquid and a second liquid into an eluent, and to supply eluents containing the second liquid with different concentrations to the chromatographic column 110 respectively. The chromatographic column 110 is configured to elute the first specimen and the second specimen with the eluents respectively. The first optical detection assembly 130 is configured to perform the chromatographic analysis on the first solution to be detected that is obtained by eluting the first specimen in the chromatographic column 110 and the second solution to be detected that is obtained by eluting the second specimen in the chromatographic column 110 respectively.

In an implementation, the first controller is configured to: control the first specimen supply device 200 to supply the first specimen to the chromatographic column 110; control the eluent supply device 120 to prepare the first liquid and the second liquid into the eluents containing the second liquid with different concentrations according to a first concentration control mode and to supply the eluents containing the second liquid with different concentrations to the chromatographic column 110 respectively, so as to elute the first specimen in the chromatographic column 110; and control the first optical detection assembly 130 to perform the chromatographic analysis on the first solution to be detected that is obtained in the chromatographic column 110. The first controller is further configured to: in response to determining that there is an interfering substance in the first specimen based on feedback information from the chromatographic separation device 100, control the first specimen supply device 200 to supply the second specimen to the chromatographic separation device 100; control the eluent supply device 120 to prepare the first liquid and the second liquid into the eluents containing the second liquid with different concentrations according to a second concentration control mode, and to supply the eluents containing the second liquid with different concentrations to the chromatographic column 110 respectively, so as to elute the second specimen in the chromatographic column 110; and control the first optical detection assembly 130 to perform the chromatographic analysis on the second solution to be detected that is obtained in the chromatographic column 110. The first concentration control mode is different from the second concentration control mode.

In an implementation, the eluent supply device 120 includes a mixing component 121, a first infusion power component 122 and a second infusion power component 123. The first infusion power component 122 is configured to deliver the first liquid from a first container 124 to the mixing component 121. The second infusion power component 123 is configured to deliver the second liquid from a second container 125 to the mixing component 121. The mixing component 121 is configured to supply the eluents formed by at least one of the first liquid and the second liquid to the chromatographic column 110. The first controller is further configured to control the mixing component 121 to supply the eluents containing the second liquid with different concentrations to the chromatographic column 110 by controlling operating parameters of the first infusion power component 122 and the second infusion power component 123, respectively.

In an implementation, duration in which the eluent supply device 120 supplies the eluent to the chromatographic column 110 according to the first concentration control mode is shorter than duration in which the eluent supply device 120 supplies the eluent to the chromatographic column 110 according to the second concentration control mode.

In an implementation, the eluent supply device 120 supplies the eluent to the chromatographic column 110 according to the first concentration control mode during a first elution stage, a second elution stage and a third elution stage arranged in sequence, and the eluent supply device 120 supplies the eluent to the chromatographic column 110 according to the second concentration control mode during a fourth elution stage, a fifth elution stage and a sixth elution stage arranged in sequence. The first elution stage and the fourth elution stage are used for eluting and analyzing glycosylated hemoglobin in the first specimen and glycosylated hemoglobin in the second specimen respectively. The second elution stage and the fifth elution stage are used for eluting and analyzing non-glycosylated hemoglobin in the first specimen and non-glycosylated hemoglobin in the second specimen respectively. The third elution stage is used for eluting and analyzing an interfering substance in the first specimen. The sixth elution stage is used for eluting and analyzing an interfering substance in the second specimen.

In an implementation, a concentration of the second liquid in an eluent used in the third elution stage is greater than a concentration of the second liquid in an eluent used in the first elution stage and greater than a concentration of the second liquid in an eluent used in the second elution stage.

In an implementation, a concentration of the second liquid in an eluent used in the sixth elution stage is greater than a concentration of the second liquid in an eluent used in the fourth elution stage and greater than a concentration of the second liquid in an eluent used in the fifth elution stage. The eluents are prepared from at least one of the first liquid and the second liquid, and an ionic strength of the first liquid is less than an ionic strength of the second liquid.

In an implementation, the concentration of the second liquid in the eluent used in the second elution stage is greater than the concentration of the second liquid in the eluent used in the first elution stage.

In an implementation, the concentration of the second liquid in the eluent used in the fifth elution stage is greater than the concentration of the second liquid in the eluent used in the fourth elution stage.

In an implementation, the first elution stage transitions to the second elution stage in a time period close to the second elution stage with a tendency to gradually increase the concentration of the second liquid in the eluent, and the fourth elution stage transitions to the fifth elution stage in a time period close to the fifth elution stage with a tendency to gradually increase the concentration of the second liquid in the eluent. The concentration of the second liquid in the eluent used in the time period, close to the second elution stage, in the first elution stage varies to a greater extent than the concentration of the second liquid in the eluent used in the time period, close to the fifth elution stage, in the fourth elution stage.

In an implementation, a concentration of the second liquid in an eluent used in a transition interval between the second elution stage and the third elution stage varies to a greater extent than a concentration of the second liquid in an eluent used in a transition interval between the fifth elution stage and the sixth elution stage.

In an implementation, duration of the fifth elution stage is longer than duration of the second elution stage.

In an implementation, duration of the sixth elution stage is longer than duration of the third elution stage.

In an implementation, duration of the first elution stage is longer than duration of the second elution stage and longer than duration of the third elution stage.

In an implementation, the sample analyzer further includes a display. The first controller is further configured to control the display to display a display interface including at least a chromatographic curve showing a glycosylated hemoglobin peak, a non-glycosylated hemoglobin peak and an interfering substance peak, after elution of the second specimen using the eluent made in the second concentration control mode and chromatographic analysis of the second solution to be detected that is obtained by eluting the second specimen by the chromatographic separation device 100 are completed.

In an implementation, the first controller is further configured to control the display to display a display interface including at least a parameter of glycosylated hemoglobin in the second specimen and a parameter of an interfering substance in the second specimen, after elution of the second specimen using the eluent made in the second concentration control mode and chromatographic analysis of the second solution to be detected that is obtained by eluting the second specimen by the chromatographic separation device 100 are completed.

Other parts and operating principles of the first sample analyzer 10 provided in this embodiment may be referred to the first embodiment and will not be described in detail here.

### Third Embodiment

A difference between a first sample analyzer 10 provided in this embodiment and the sample analyzer in the first embodiment mainly lies in a different protection emphasis, which is embodied in the following aspects: the first embodiment focuses on the protection of the detection results of the first operation mode and the second operation mode; whereas this embodiment focuses on the protection of using the same chromatographic column 110 to perform the elution of the specimen in the first and second operation modes respectively, and using the same eluent supply device 120 to supply the eluents to the chromatographic column 110 in the first and second operation modes respectively.

Specifically, the sample analyzer provided in this embodiment includes a first specimen supply device 200, a chromatographic separation device 100 and a first controller. The first specimen supply device 200 is configured to convey a first specimen to the chromatographic separation device 100. The chromatographic separation device 100 is controlled by the first controller to elute and perform chromatographic analysis on the first specimen in a first operation mode, and to elute and perform chromatographic analysis on the first specimen in a second operation mode. The chromatographic separation device 100 includes a chromatographic column 110, an eluent supply device 120 and a first optical detection assembly 130. The first specimen supply device 200 is configured to supply at least the first specimen and a second specimen to the chromatographic column 110 respectively. The eluent supply device 120 is configured to convey eluents to the chromatographic column 110. The chromatographic column 110 is configured to elute the first specimen with the eluent and elute the second specimen with the eluent. The first optical detection assembly 130 is configured to perform chromatographic analysis on a first solution to be detected that is obtained by eluting the first specimen in the chromatographic column 110 and perform chromatographic analysis on a second solution to be detected that is obtained by eluting the second specimen in the chromatographic column 110. The first controller is further configured to control the chromatographic separation device 100 to elute the first specimen in the first operation mode and elute the second specimen in the second operation mode, using the same chromatographic column 110, respectively, and to control the chromatographic separation device 100 to supply the eluents to the chromatographic column 110 in the first operation mode and the second operation mode using the same eluent supply device 120, respectively. The embodiment can reduce the quantity of materials and the cost of materials while maintaining both the measuring speed and accuracy.

In an implementation, the eluent supply device 120 includes a mixing component 121, a first infusion power component 122 for conveying a first liquid from a first container 124 to the mixing component 121, and a second infusion power component 12 for conveying a second liquid from a second container 125 to the mixing component 121. The mixing component 121 is configured to prepare the first liquid and/or the second liquid into the eluents and to supply the eluents to the chromatographic column 110.

In an implementation, the first controller is further configured to control the mixing component 121 to supply the eluents containing the second liquid with different concentrations to the chromatographic column by controlling operating parameters of the first infusion power component 122 and the second infusion power component 123 respectively.

Other parts and operating principles of the first sample analyzer 10 provided in this embodiment can be referred to the first embodiment and will not be described in detail here.

### Fourth Embodiment

A difference between a first sample analyzer 10 provided in this embodiment and the sample analyzer in the first embodiment mainly lies in a different protection emphasis, which is embodied in the following aspects: the first embodiment focuses on the protection of the detection results of the first operation mode and the second operation mode; whereas this embodiment focuses on the protection of preparing a set of eluent stock solution formed by the first liquid and the second liquid into eluents used in different operation modes online by adopting different concentration control modes in the first operation mode and the second operation mode respectively.

Specifically, the first sample analyzer 10 provided in this embodiment includes a first specimen supply device 200, a chromatographic separation device 100 and a first controller. The first specimen supply device 200 is configured to supply at least a first specimen and a second specimen to the chromatographic separation device 100 respectively. The chromatographic separation device 100 is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode. The chromatographic separation device 100 includes a chromatographic column 110, an eluent supply device 120 and a first optical detection assembly 130. The first specimen supply device 200 is configured to convey the first specimen and the second specimen to the chromatographic column 110 respectively. The eluent supply device 120 is controlled by the first controller to prepare an eluent from a first liquid and a second liquid and convey eluents containing the second liquid with different concentrations to the chromatographic column 110. The chromatographic column 110 is configured to elute the first specimen and the second specimen with the eluents respectively. The first optical detection assembly 130 is configured to perform the chromatographic analysis on the first solution to be detected and the second solution to be detected eluted in the chromatographic column 110 respectively. The first controller is further configured to control the eluent supply device 120 to prepare the first liquid and the second liquid into the eluents containing the second liquid with different concentrations according to a first concentration control mode in the first operation mode, and to supply the eluents containing the second liquid with different concentrations to the chromatographic column 110 respectively to elute the first specimen in the chromatographic column 110. The first controller is further configured to control the eluent supply device 120 to prepare the first liquid and the second liquid into eluents containing the second liquid with different concentrations according to a second concentration control mode in the second operation mode, and to supply the eluents containing the second liquid with different concentrations to the chromatographic column 110 respectively to elute the second specimen in the chromatographic column 110. The first concentration control mode is different from the second concentration control mode. In this embodiment, a set of eluent stock solution formed by the first liquid and the second liquid is prepared online into eluents used in different operation modes by adopting different concentration control modes, which has less materials and low material cost, and can give attention to measurement speed and measurement accuracy respectively by adopting different operation modes.

In an implementation, there is one chromatographic columns 110, and the first controller is configured to control the chromatographic separation device 100 to elute the first specimen in the first operation mode and elute the second specimen in the second operation mode, using the same chromatographic column 110, respectively, and to control the chromatographic separation device 100 to supply the eluents to the chromatographic columns 110 in the first operation mode and the second operation mode, using the same eluent supply device 120, respectively.

In an implementation, the eluent supply device 120 includes a mixing component 121, a first infusion power component 122 for conveying the first liquid from a first container 124 to the mixing component 121, and a second infusion power component 123 for conveying the second liquid from a second container 125 to the mixing component 121. The mixing component 121 is configured to prepare the first liquid and/or the second liquid into the eluents and to supply the eluents to the chromatographic column 110.

In an implementation, the first controller is further configured to control the mixing component 121 to supply the eluents containing the second liquid with different concentrations to the chromatographic column by controlling operating parameters of the first infusion power component 122 and the second infusion power component 123 respectively.

Other parts and operating principles of the first sample analyzer 10 provided in this embodiment can be referred to the first embodiment and will not be described in detail here.

### Fifth Embodiment

A difference between a first sample analyzer 10 provided in this embodiment and the sample analyzer in the first embodiment mainly lies in a different protection emphasis, which is embodied in the following aspects: the first embodiment focuses on the protection of the detection results of the first operation mode and the second operation mode; whereas the embodiment focuses on the protection of automatically switch to the second operation mode from the first operation mode when an interfering substance is detected in the first operation mode.

Specifically, the first sample analyzer 10 provided in this embodiment includes a first specimen supply device 200, a chromatographic separation device 100 and a first controller. The first specimen supply device 200 is configured to supply at least a first specimen and a second specimen to the chromatographic separation device 100 respectively. The chromatographic separation device 100 is controlled by the first controller to elute the first specimen and performing chromatographic analysis on a first solution to be detected that is obtained by eluting the first specimen in a first operation mode, and to elute the second specimen and perform chromatographic analysis on a second solution to be detected that is obtained by eluting the second specimen in a second operation mode. The first controller is configured to: in response to determining that there is an interfering substance in the first specimen based on feedback information from the chromatographic separation device 100 in the first operation mode, control the first specimen supply device 200 to supply the second specimen to the chromatographic separation device 100, and to control the chromatographic separation device 100 to elute the second specimen and to perform the chromatographic analysis on the second solution to be detected that is obtained by eluting the second specimen in the second operation mode. The first sample analyzer 10 provided in this embodiment automatically switches to the second operation mode when the interfering substance is detected in the first operation mode without the participation of an operator.

Other parts and operating principles of the first sample analyzer 10 provided in this embodiment can be referred to the first embodiment and will not be described in detail here.

### Sixth Embodiment

A first sample analyzer 10 provided in this embodiment differs from the first sample analyzer 10 in the fifth embodiment mainly in that the mode of switching to the second operation mode is different when the interfering substance is detected in the first operation mode. Specifically, in the fifth embodiment, when the interfering substance is detected in the first operation mode, the second operation mode is automatically switched; whereas in the present embodiment, when the interfering substance is detected in the first operation mode, the operator is prompted, and when information input by the operator for switching to the second operation mode is received, the second operation mode is switched.

Specifically, the first sample analyzer 10 provided in this embodiment includes a first specimen supply device 200, a chromatographic separation device 100, a display and a first controller. The first specimen supply device 200 is configured to supply at least a first specimen and a second specimen to the chromatographic separation device 100 respectively. The chromatographic separation device 100 is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode. The first controller is configured to: in response to determining that there is the interfering substance in the first specimen based on feedback information from the chromatographic separation device 100 in the first operation mode, control the display to display a display interface including at least prompt information of presence of an interfering substance in the first specimen and prompt information as to whether to switch to the second operation mode. The first controller is further configured to: obtain an instruction for switching to the second operation mode, control the first specimen supply device 200 to supply the second specimen to the chromatographic separation device 100, and control the chromatographic separation device 100 to elute the second specimen and perform the chromatographic analysis on the second solution to be detected that is obtained by eluting the second specimen in the second operation mode. In the first sample analyzer 10 provided in this embodiment, when an interfering substance is detected in the first operation mode, an operator is required to operate the first sample analyzer 10 before switching to the second operation mode.

Other parts and operating principles of the first sample analyzer 10 provided in this embodiment can be referred to the first embodiment and will not be described in detail here.

### Seventh Embodiment

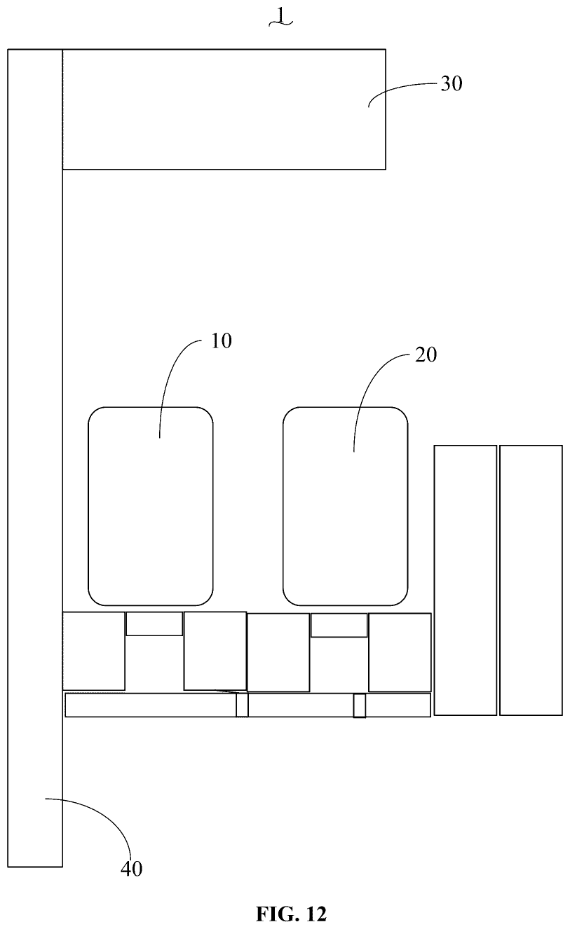

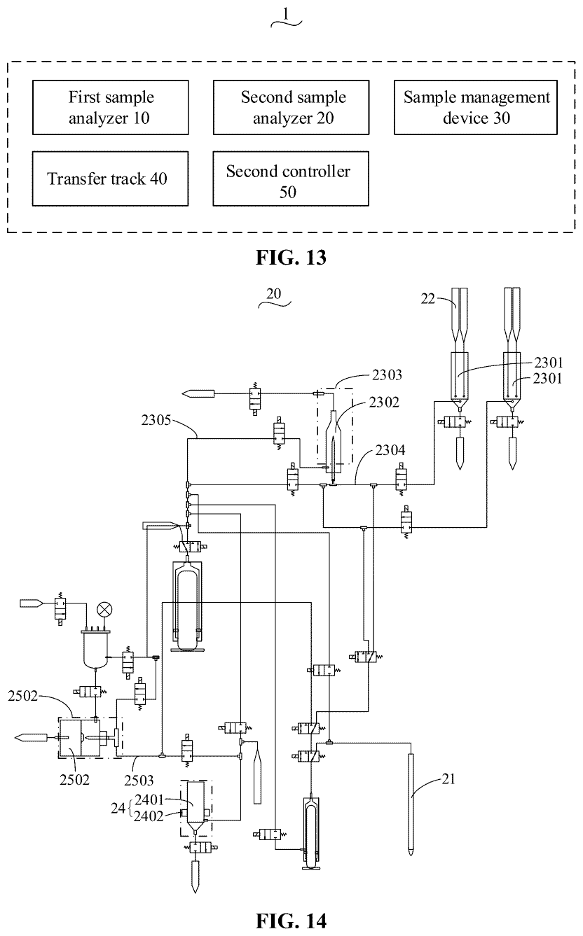

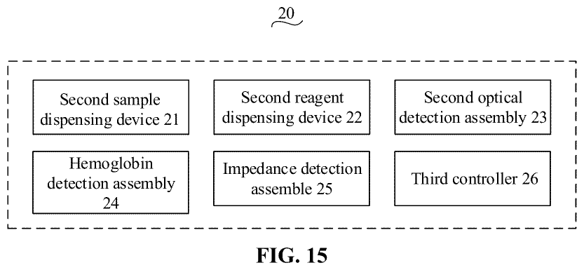

Referring to FIGS. 1 to 3 and FIGS. 12 to 15, a difference between the present embodiment and the first embodiment mainly lies in different application scenarios of glycosylated hemoglobin measurement. Specifically, the first embodiment is applied to a single glycosylated hemoglobin analyzer; whereas the present embodiment is applied to the scenario of a cascade system or an assembly line having a glycosylated hemoglobin analyzer.

Specifically, the present embodiment provides a sample analysis system 1 including a sample management device 30, a first sample analyzer 10, a second sample analyzer 20, a transfer track 40 and a second controller 50. The sample management device 30 is configured to at least place a sample container loaded with a sample to realize the feeding of the sample. The first sample analyzer 10 is configured to aspirate the sample from the sample container to perform a glycosylated hemoglobin test item. The second sample analyzer 20 is configured to aspirate the sample from the sample container to perform a blood routine test item. The transfer track 40 extends from the sample management device 30 to the first sample analyzer 10 and the second sample analyzer 20. The second controller 50 is configured to control the transfer track 40 to transfer the sample container to the first sample analyzer 10 and/or the second sample analyzer 20. In a specific application, an operator or an operating robot may place the sample container loaded with the sample on the sample management device 30 for loading, and the second controller 50 may control the transfer track 40 to transfer the sample output from the sample management device 30 to the first sample analyzer 10 and/or the second sample analyzer 20 for aspirating. The sample analysis system 1 provided by the embodiment integrates the blood routine test function and the glycosylated hemoglobin test function, which is beneficial to simultaneously realize the testing of the blood routine test item and the glycosylated hemoglobin test item through one tube of blood, thereby reducing the sample requirement.

In an implementation, the sample management device 30 is provided with an information acquisition component for identifying an identification code of the sample container and/or an appearance feature of the sample container. The second controller 50 is configured to control the transfer track 40 to transfer the sample container to the first sample analyzer 10 and/or the second sample analyzer 20 for aspirating based on feedback information from the information acquisition component. Specifically, the second controller 50 is configured to determine a type of item to be detected for the sample in the sample container based on the feedback information from the information acquisition component, and control the transfer track 40 to transfer the sample container to the first sample analyzer 10 and/or the second sample analyzer 20 for aspirating according to the type of the item to be detected for the sample in the sample container. In the embodiment, the sample analysis system 1 automatically dispatches the sample container to the corresponding analyzer to aspirate sample by automatically identifying the sample container, without any operation by an operator, so that the operator can basically have no sense of sorting and dispatching the sample, and the automation degree of the sample analysis system 1 is improved.

In an implementation, the first sample analyzer 10 includes a first specimen supply device 200, a chromatographic separation device 100 and a first controller. The first specimen supply device 200 is configured to aspirate the sample from the sample container to prepare a first specimen and supply the first specimen to the chromatographic separation device 100. The chromatographic separation device 100 is controlled by the first controller to elute the first specimen and perform chromatographic analysis on a first solution to be detected that is obtained by eluting the first specimen in a first operation mode, and to elute a second specimen and perform chromatographic analysis on a second solution to be detected that is obtained by eluting the second specimen in a second operation mode. The first controller is configured to analyze feedback information from the chromatographic separation device 100 in the first operation mode to obtain a parameter of glycosylated hemoglobin in the first specimen and a conclusion as to whether there is an interfering substance in the first specimen. The first controller is further configured to analyze feedback information from the chromatographic separation device 100 in the second operation mode to obtain a parameter of glycosylated hemoglobin in the second specimen and a parameter of an interfering substance in the second specimen.

In an implementation, the chromatographic separation device 100 includes a chromatographic column 110, an eluent supply device 120, and a first optical detection assembly 130. The first specimen supply device 200 is configured to supply at least the first specimen and the second specimen to the chromatographic column 110, respectively. The eluent supply device 120 is controlled by the first controller to prepare a first liquid and a second liquid into an eluent, and to supply eluents containing the second liquid with different concentrations to the chromatographic column 110 respectively. The chromatographic column 110 is configured to elute the first specimen and the second specimen with the eluents respectively. The first optical detection assembly 130 is configured to perform the chromatographic analysis on the first solution to be detected and the second solution to be detected eluted from the chromatographic column respectively. The first controller is further configured to control the eluent supply device 120 to prepare the first liquid and the second liquid into the eluents containing the second liquid with different concentrations according to a first concentration control mode in the first operation mode, and to supply the eluents containing the second liquid with different concentrations to the chromatographic column 110 respectively, so as to elute the first specimen in the chromatographic column 110. The first controller is further configured to control the eluent supply device 120 to prepare the first liquid and the second liquid into the eluents containing the second liquid with different concentrations according to a second concentration control mode in the second operation mode, and to supply the eluents containing the second liquid with different concentrations to the chromatographic column 110 respectively, so as to elute the second specimen in the chromatographic column 110. The first concentration control mode is different from the second concentration control mode.

In an implementation, the first controller is further configured to control the chromatographic separation device 100 to elute the first specimen in the first operation mode and elute the second specimen in the second operation mode, using the same chromatographic column 110, respectively.

In an implementation, elution duration of the first specimen by the chromatographic separation device 100 in the first operation mode is shorter than that of the second specimen by the chromatographic separation device 100 in the second operation mode.

In an implementation, the first controller is further configured to: in response to determining that there is an interfering substance in the first specimen based on the feedback information from the chromatographic separation device 100 in the first operation mode, control the first specimen supply device 200 to supply the second specimen to the chromatographic separation device 100, and to control the chromatographic separation device 100 to elute the second specimen and to perform the chromatographic analysis on the second solution to be detected that is obtained by eluting the second specimen in the second operation mode.

In an implementation, the first specimen supply device 200 includes a first sample dispensing device, a first reagent dispensing device, a first reaction cell and a first specimen conveying device. The first sample dispensing device is configured to aspirate the sample from the sample container and dispense at least part of the aspirated sample into the first reaction cell. The first reagent dispensing device is configured to aspirate a reagent from a reagent container and dispense the aspirated reagent into the first reaction cell. The first reaction cell is configured to prepare the sample and the reagent into a specimen. The first specimen conveying device is configured to convey the specimen from the first reaction cell to the chromatographic separation device 100. The first controller is configured to control the first specimen supply device 200 to supply the second specimen to the chromatographic separation device 100 by: controlling the first sample dispensing device to re-aspirate the sample from the sample container and dispense at least part of the re-aspirated sample into the first reaction cell, controlling the first reagent dispensing device to aspirate the reagent from the reagent container and dispense the aspirated reagent into the first reaction cell, controlling the first reaction cell to prepare the sample and the reagent into the second specimen, and controlling the first specimen supply device 200 to supply the second specimen to the chromatographic separation device 100.

In an implementation, the first sample analyzer 10 further includes a display. The first controller is further configured to control the display to display a display interface including at least a chromatographic curve showing a glycosylated hemoglobin peak, a non-glycosylated hemoglobin peak and an interfering substance peak, after elution of the second specimen and chromatographic analysis of the second solution to be detected that is obtained by eluting the second specimen by the chromatographic separation device 100 in the second operation mode are completed.

In an implementation, the first controller is further configured to: in response to determining that there is the interfering substance in the first specimen based on the feedback information from the chromatographic separation device 100 in the first operation mode, control the display to display a display interface including at least the parameter of the glycosylated hemoglobin in the first specimen and prompt information of presence of the interfering substance in the first specimen.

In an implementation, the first controller is further configured to: in response to determining that there is no interfering substance in the first specimen based on the feedback information from the chromatographic separation device 100 in the first operation mode, control the display to display a display interface including at least the parameter of the glycosylated hemoglobin in the first specimen.

In an implementation, the first controller is further configured to: in response to determining that there is the interfering substance in the first specimen based on the feedback information from the chromatographic separation device 100 in the first operation mode, control the display to display a display interface including at least prompt information of presence of the interfering substance in the first specimen and prompt information as to whether to switch to the second operation mode. The first controller is further configured to: obtain an instruction for switching to the second operation mode, control the first specimen supply device 200 to supply the second specimen to the chromatographic separation device 100, and control the chromatographic separation device 100 to elute the second specimen and perform the chromatographic analysis on the second solution to be detected that is obtained by eluting the second specimen in the second operation mode.

In an implementation, the chromatographic separation device 100 is further controlled by the first controller to elute a third specimen and perform chromatographic analysis on a third solution to be detected that is obtained by eluting the third specimen in a third operation mode. The first controller is further configured to analyze feedback information from the chromatographic separation device 100 in the third operation mode to obtain a parameter of glycosylated hemoglobin in the third specimen. An elution time of the third specimen by the chromatographic separation device 100 in the third operation mode is shorter than that of the first specimen by the chromatographic separation device 100 in the first operation mode.

In an implementation, the first sample dispensing device includes a first sample needle, a first motion drive component for driving the first sample needle to move, and a first aspiration and discharge drive component for driving the first sample needle to aspirate and discharge the sample.

In an implementation, the second sample analyzer 20 includes a second sample dispensing device 21, a second reagent dispensing device 22 and a measurement assembly. The second sample dispensing device 21 is configured to aspirate the sample from the sample container and dispense the aspirated sample to the measurement assembly. The second reagent dispensing device 22 is configured to dispense the reagent to the measurement assembly. The measurement assembly is configured to measure at least the second specimen made of the sample dispensed by the first sample dispensing device and the reagent dispensed by the reagent dispensing device.

In an implementation, the measurement assembly of the second sample analyzer 20 includes a second optical detection assembly 23 for leukocyte classification count detection and reticulocyte count detection, a hemoglobin detection assembly 24 for hemoglobin concentration detection, and an impedance detection assembly 25 for red blood cell and platelet detection. The second optical detection assembly 23 includes a second reaction cell 2301, a flow chamber 2302, an optical detection component 2303, a first sample preparation pipeline 2304 and a sheath liquid pipeline 2305. The first sample preparation pipeline 2304 is connected between the second reaction cell 2301 and the flow chamber 2302 and configured to push a fourth specimen made of the sample and the reagent in the second reaction cell 2301 to the flow chamber 2302, and the sheath liquid pipeline 2305 is configured to convey a sheath liquid to the flow chamber 2302. The flow chamber 2302 has a detection area, and cells to be detected in the fourth specimen for leukocyte or reticulocyte detection are lined up and passed through the detection area under the sheath fluid. The optical detection component 2303 is configured to perform leukocyte classification counting detection or reticulocyte counting detection on the specimen carried by the sheath fluid and passing through the detection area of the flow chamber 2302, and obtain a detection result of the leukocyte or reticulocyte based on a scattered light signal and/or a fluorescence signal. The hemoglobin detection assembly 24 includes a hemoglobin detection cell 2401 and a hemoglobin detection element 2402, and the impedance detection assembly 25 includes an impedance detection cell 2501, an impedance detector 2502, and a second sample preparation pipeline 2503 connected between the hemoglobin detection cell 2401 and the impedance detection cell 2501. The hemoglobin detection cell 2401 is used as a preparation unit for an impedance counting detection sample in addition to a preparation unit and a detection unit for a hemoglobin detection sample. In a specific operation, the sample can be added into the hemoglobin detection cell 2401 and reacted with diluent to prepare an impedance counting detection specimen, and then part of the impedance counting detection specimen is pumped away. Then, the reagent is added to the hemoglobin detection cell 2401 to prepare a hemoglobin detection specimen. The second sample dispensing device 21 is configured to dispense the sample from the sample container and dispense the sample to the second reaction cell 2301 and the hemoglobin detection cell 2401.

In an implementation, the optical detection component 2303 includes a light source, a forward scattering light signal collecting means, a lateral scattering light signal collecting means and a fluorescence signal collecting means. The light source is configured to emit light toward the cells to be detected flowing through the flow chamber 2302. The forward scattering light signal collecting means is configured to collect a forward scattering signal generated by the light source irradiating the cell to be detected, and the forward scattering signal (also called a low angle scattering signal) collected by the forward scattering light signal collecting means may characterize a volume of the cell to be detected. The lateral scattering light signal collecting means is configured to collect a lateral scattering signal generated by the light source irradiating the cell to be detected. The lateral scattering signal collecting means is arranged at a lateral side of an optical axis of the light emitted by the light source, and the collected lateral scattering signal (also called a high angle scattering signal) may characterize a complexity of particles in the cell to be detected. The fluorescence signal collecting means is configured to collect a fluorescence signal generated by the light source irradiating the cell to be detected. The fluorescence signal collecting means is arranged at the lateral side of the optical axis of the light emitted by the light source, and an intensity of the collected fluorescence signal may characterize a degree of staining of the cell to be detected.

In an implementation, the second sample dispensing device 21 includes a second sample needle, a second motion drive component for driving the second sample needle to move, and a second aspiration and discharge drive component for driving the second sample needle to aspirate and discharge the sample.

In an implementation, the second sample analyzer 20 further includes a third controller 26 for controlling the operation of the second sample dispensing device 21, the second reagent dispensing device 22, the second optical detection assembly 23, the hemoglobin detection assembly 24, and the impedance detection assembly 25.

In an implementation, there may be one or multiple first sample analyzers 10 and second sample analyzers 20.

Other parts and operating principles of the sample analysis system 1 provided in this embodiment can be referred to the first embodiment to the sixth embodiment, and will not be described in detail here.

The above are only preferred embodiments of the disclosure, and are not intended to limit the scope of the disclosure. Any equivalent structural transformation made by using the contents of the specification and drawings, or direct/indirect application in other related technical field, under the inventive concept of the disclosure, shall fall within the scope of protection of the disclosure.

1. A sample analyzer, comprising a first specimen supply device, a chromatographic separation device and a first controller; wherein
the first specimen supply device is configured to supply at least a first specimen and a second specimen to the chromatographic separation device, respectively;
the chromatographic separation device is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode;
the first controller is configured to analyze feedback information from the chromatographic separation device in the first operation mode to obtain a parameter of glycosylated hemoglobin in the first specimen and a conclusion as to whether there is an interfering substance in the first specimen; and
the first controller is further configured to analyze feedback information from the chromatographic separation device in the second operation mode to obtain a parameter of glycosylated hemoglobin in the second specimen and a parameter of an interfering substance in the second specimen.

2. The sample analyzer of claim 1, wherein
the chromatographic separation device comprises a chromatographic column, an eluent supply device and a first optical detection assembly;
the first specimen supply device is configured to supply at least the first specimen and the second specimen to the chromatographic column, respectively;
the eluent supply device is controlled by the first controller to prepare at least one of a first liquid and a second liquid into an eluent, and to supply eluents containing the second liquid with different concentrations to the chromatographic column respectively;
the chromatographic column is configured to elute the first specimen and the second specimen with the eluents respectively;
the first optical detection assembly is configured to perform the chromatographic analysis on the first solution to be detected that is obtained by eluting the first specimen in the chromatographic column and the second solution to be detected that is obtained by eluting the second specimen in the chromatographic column respectively;
the first controller is further configured to control the eluent supply device to prepare at least one of the first liquid and the second liquid into the eluents containing the second liquid with different concentrations according to a first concentration control mode in the first operation mode, and to supply the eluents containing the second liquid with different concentrations to the chromatographic column respectively, so as to elute the first specimen in the chromatographic column;
the first controller is further configured to control the eluent supply device to prepare at least one of the first liquid and the second liquid into the eluents containing the second liquid with different concentrations according to a second concentration control mode in the second operation mode, and to supply the eluents containing the second liquid with different concentrations to the chromatographic column respectively, so as to elute the second specimen in the chromatographic column; wherein
the first concentration control mode is different from the second concentration control mode.

3. The sample analyzer of claim 2, wherein the first controller is further configured to control the chromatographic separation device to elute the first specimen in the first operation mode and elute the second specimen in the second operation mode, using the same chromatographic column.

4. The sample analyzer of claim 3, wherein
the eluent supply device comprises a mixing component, a first infusion power component and a second infusion power component;
the first infusion power component is configured to deliver the first liquid from a first container to the mixing component;
the second infusion power component is configured to deliver the second liquid from a second container to the mixing component;
the mixing component is configured to supply the eluents formed by at least one of the first liquid and the second liquid to the chromatographic column; and
the first controller is further configured to control the mixing component to supply the eluents containing the second liquid with different concentrations to the chromatographic column by controlling operating parameters of the first infusion power component and the second infusion power component, respectively.

5. The sample analyzer of claim 1, wherein an elution duration of the first specimen by the chromatographic separation device in the first operation mode is shorter than that of the second specimen by the chromatographic separation device in the second operation mode.

6. The sample analyzer of claim 1, wherein the first operation mode comprises a first elution stage, a second elution stage and a third elution stage arranged in sequence, and the second operation mode comprises a fourth elution stage, a fifth elution stage and a sixth elution stage arranged in sequence;
the first elution stage and the fourth elution stage are used for eluting and analyzing the glycosylated hemoglobin in the first specimen and the glycosylated hemoglobin in the second specimen respectively; the second elution stage and the fifth elution stage are used for eluting and analyzing non-glycosylated hemoglobin in the first specimen and non-glycosylated hemoglobin in the second specimen respectively; the third elution stage is used for eluting and analyzing the interfering substance in the first specimen; and the sixth elution stage is used for eluting and analyzing the interfering substance in the second specimen;
a concentration of the second liquid in an eluent used in the third elution stage is greater than a concentration of the second liquid in an eluent used in the first elution stage and greater than a concentration of the second liquid in an eluent used in the second elution stage;
a concentration of the second liquid in an eluent used in the sixth elution stage is greater than a concentration of the second liquid in an eluent used in the fourth elution stage and greater than a concentration of the second liquid in an eluent used in the fifth elution stage; and wherein
the eluents are prepared from at least one of the first liquid and the second liquid, and an ionic strength of the first liquid is less than an ionic strength of the second liquid.

7. The sample analyzer of claim 6, wherein
the concentration of the second liquid in the eluent used in the second elution stage is greater than the concentration of the second liquid in the eluent used in the first elution stage; and
the concentration of the second liquid in the eluent used in the fifth elution stage is greater than the concentration of the second liquid in the eluent used in the fourth elution stage.

8. The sample analyzer of claim 6, wherein a concentration of the second liquid in an eluent used in a transition interval between the second elution stage and the third elution stage varies to a greater extent than a concentration of the second liquid in an eluent used in a transition interval between the fifth elution stage and the sixth elution stage.

9. The sample analyzer of claim 6, wherein
a duration of the fifth elution stage is longer than a duration of the second elution stage; or,
a duration of the sixth elution stage is longer than a duration of the third elution stage.

10. The sample analyzer of claim 6, wherein
duration of the first elution stage is longer than duration of the second elution stage and longer than duration of the third elution stage.

11. The sample analyzer of claim 6, wherein the first controller is further configured to:
analyze the feedback information from the chromatographic separation device to obtain a chromatographic curve in the first operation mode;
determine that the interfering substance is in the first specimen when more than two peaks are formed in the chromatographic curve obtained in the second elution stage and the third elution stage; or,
the first controller is further configured to analyze the feedback information from the chromatographic separation device to obtain a chromatographic curve in the second operation mode, wherein said chromatographic curve obtained in the fifth elution stage and the sixth elution stage shows more than two peaks.

12. The sample analyzer of claim 1, wherein the first controller is further configured to:
control the first specimen supply device to supply the second specimen to the chromatographic separation device in response to determining that the interfering substance is in the first specimen based on the feedback information from the chromatographic separation device in the first operation mode; and
control the chromatographic separation device to elute the second specimen and to perform the chromatographic analysis on the second solution to be detected that is obtained by eluting the second specimen in the second operation mode.

13. The sample analyzer of claim 12, wherein
the first specimen supply device comprises a first sample dispensing device, a first reagent dispensing device, a first reaction cell and a first specimen conveying device;
the first sample dispensing device is configured to aspirate a sample from a sample container and dispense at least part of the aspirated sample into the first reaction cell;
the first reagent dispensing device is configured to aspirate a reagent from a reagent container and dispense the aspirated reagent into the first reaction cell;
the first reaction cell is configured to prepare the sample and the reagent into a specimen; and
the first specimen conveying device is configured to convey the specimen from the first reaction cell to the chromatographic separation device; and
the first controller is configured to control the first specimen supply device to supply the second specimen to the chromatographic separation device by:
controlling the first sample dispensing device to re-aspirate the sample from the sample container and dispense at least part of the re-aspirated sample into the first reaction cell;
controlling the first reagent dispensing device to aspirate the reagent from the reagent container and dispense the aspirated reagent into the first reaction cell;
controlling the first reaction cell to prepare the sample and the reagent into the second specimen; and
controlling the first specimen conveying device to supply the prepared second specimen to the chromatographic separation device.

14. The sample analyzer of claim 1, further comprising a display, wherein
the first controller is further configured to control the display to display a display interface comprising at least the parameter of the glycosylated hemoglobin in the first specimen and prompt information of the existence of the interfering substance in the first specimen in response to determining that the interfering substance is in the first specimen based on the feedback information from the chromatographic separation device in the first operation mode.

15. The sample analyzer of claim 1, further comprising a display, wherein the first controller is further configured to:
control the display to display a display interface comprising prompt information indicating presence of the interfering substance in the first specimen and prompt information of whether to switch to the second operation mode in response to the existence of the interfering substance in the first specimen based on the feedback information from the chromatographic separation device in the first operation mode;
obtain an instruction for switching to the second operation mode;
control the first specimen supply device to supply the second specimen to the chromatographic separation device; and
control the chromatographic separation device to elute the second specimen and perform the chromatographic analysis on the second solution to be detected that is obtained by eluting the second specimen in the second operation mode.

16. The sample analyzer of claim 1, wherein
the chromatographic separation device is further controlled by the first controller to elute a third specimen and perform chromatographic analysis on a third solution to be detected that is obtained by eluting the third specimen in a third operation mode;
the first controller is further configured to analyze feedback information from the chromatographic separation device in the third operation mode to obtain a parameter of glycosylated hemoglobin in the third specimen; and
an elution duration of the third specimen by the chromatographic separation device in the third operation mode is shorter than that of the first specimen by the chromatographic separation device in the first operation mode.

17. The sample analyzer of claim 16, wherein the chromatographic separation device comprises a chromatographic column, an eluent supply device and a first optical detection assembly;
the first specimen supply device is configured to supply the first specimen, the second specimen and the third specimen to the chromatographic column, respectively;
the eluent supply device is controlled by the first controller to prepare at least one of a first liquid and a second liquid into an eluent, and to supply eluents containing the second liquid with different concentrations to the chromatographic column respectively;
the chromatographic column is configured to elute the first specimen, the second specimen and the third specimen with the eluents respectively;
the first optical detection assembly is configured to perform the chromatographic analysis on the first solution to be detected that is obtained by eluting the first specimen in the chromatographic column, the second solution to be detected that is obtained by eluting the second specimen in the chromatographic column, and a third solution to be detected that is obtained by eluting the third specimen in the chromatographic column, respectively;
the first controller is further configured to control the eluent supply device to prepare at least one of a first liquid and a second liquid into eluents containing the second liquid with different concentrations according to a first concentration control mode in the first operation mode, and to
supply the eluents containing the second liquid with different concentrations to the chromatographic column respectively, so as to elute the first specimen in the chromatographic column;
the first controller is further configured to control the eluent supply device to prepare at least one of the first liquid and the second liquid into eluents containing the second liquid with different concentrations according to a second concentration control mode in the second operation mode, and to supply the eluents containing the second liquid with different concentrations to the chromatographic column respectively, so as to elute the second specimen in the chromatographic column; and
the first controller is further configured to control the eluent supply device to prepare at least one of the first liquid and the second liquid into eluents containing the second liquid with different concentrations according to a third concentration control mode in the third operation mode, and to supply the eluents containing the second liquid with different concentrations to the chromatographic column respectively, so as to elute the third specimen in the chromatographic column, wherein
the first concentration control mode, the second concentration control mode and the third concentration control mode are different from one another.

18. The sample analyzer of claim 17, wherein the first controller is further configured to control the chromatographic separation device to elute the first specimen in the first operation mode, elute the second specimen in the second operation mode and elute the third specimen in the third operation mode, using the same chromatographic column.

19. A sample analyzer, comprising a first specimen supply device, a chromatographic separation device and a first controller; wherein
the first specimen supply device is configured to supply at least a first specimen and a second specimen to the chromatographic separation device, respectively;
the chromatographic separation device is controlled by the first controller to elute the first specimen and perform chromatographic analysis on a first solution to be detected that is obtained by eluting the first specimen, and to elute the second specimen and perform chromatographic analysis on a second solution to be detected that is obtained by eluting the second specimen;
the chromatographic separation device comprises a chromatographic column, an eluent supply device and a first optical detection assembly;
the first specimen supply device is configured to supply at least the first specimen and the second specimen to the chromatographic column, respectively;
the eluent supply device is controlled by the first controller to prepare at least one of a first liquid and a second liquid into an eluent, and to supply eluents containing the second liquid with different concentrations to the chromatographic column respectively; the chromatographic column is configured to elute the first specimen and the second specimen with the eluents respectively; the first optical detection assembly is configured to perform the chromatographic analysis on the first solution to be detected that is obtained by eluting the first specimen in the chromatographic column and the second solution to be detected that is obtained by eluting the second specimen in the chromatographic column respectively;
the first controller is configured to:
control the first specimen supply device to supply the first specimen to the chromatographic column;
control the eluent supply device to prepare at least one of the first liquid and the second liquid into the eluents containing the second liquid with different concentrations according to a first concentration control mode;
supply the eluents containing the second liquid with different concentrations to the chromatographic column respectively, so as to elute the first specimen in the chromatographic column; and
control the first optical detection assembly to perform the chromatographic analysis on the first solution to be detected that is obtained in the chromatographic column;
the first controller is further configured to:
control the first specimen supply device to supply the second specimen to the chromatographic separation device in response to determining that the interfering substance is in the first specimen based on feedback information from the chromatographic separation device;
control the eluent supply device to prepare at least one of the first liquid and the second liquid into the eluents containing the second liquid with different concentrations according to a second concentration control mode;
supply the eluents containing the second liquid with different concentrations to the chromatographic column respectively, so as to elute the second specimen in the chromatographic column; and
control the first optical detection assembly to perform the chromatographic analysis on the second solution to be detected that is obtained in the chromatographic column;
the first concentration control mode is different from the second concentration control mode.

20. A sample analysis system, comprising:
a sample management device configured to place a sample container loaded with a sample;
a first sample analyzer configured to aspirate the sample from the sample container to perform a glycosylated hemoglobin test item;
a second sample analyzer configured to aspirate the sample from the sample container to perform a blood routine test item;
a transfer track extending from the sample management device to the first sample analyzer and the second sample analyzer;
a second controller configured to control the transfer track to transfer the sample container to at least one of the first sample analyzer and the second sample analyzer;
the first sample analyzer comprising a first specimen supply device, a chromatographic separation device and a first controller; wherein
the first specimen supply device is configured to aspirate the sample from the sample container to prepare a first specimen and supply the first specimen to the chromatographic separation device, and to aspirate the sample from the sample container to prepare a second specimen and supply the second specimen to the chromatographic separation device;
the chromatographic separation device is controlled by the first controller to elute the first specimen and perform chromatographic analysis on a first solution to be detected that is obtained by eluting the first specimen in a first operation mode, and to elute the second specimen and perform chromatographic analysis on a second solution to be detected that is obtained by eluting the second specimen in a second operation mode;
the first controller is configured to analyze feedback information from the chromatographic separation device in the first operation mode to obtain a parameter of glycosylated hemoglobin in the first specimen and a conclusion as to whether there is an interfering substance in the first specimen; and the first controller is further configured to analyze feedback information from the chromatographic separation device in the second operation mode to obtain a parameter of glycosylated hemoglobin in the second specimen and a parameter of an interfering substance in the second specimen.
